(19) United States
(12) Patent Application Publication
(10) Pub. No.: US 2012/0059750 A1
(43) Pub. Date: Mar. 8, 2012

(54) System and Method for Regulatory Assessment of Financial Institutions

(76) Inventors: Kamal Mustafa, North Caldwell, NJ (US); Adam Mustafa, Alexandria, VA (US); Todd Dellacamera, Wilton, CT (US)

(21) Appl. No.: 13/016,922

(22) Filed: Jan. 28, 2011

Related U.S. Application Data
(63) Continuation-in-part of application No. 12/849,744, filed on Aug. 3, 2010.
(60) Provisional application No. 61/230,906, filed on Aug. 3, 2009.
(60) Provisional application No. 61/299,711, filed on Jan. 29, 2010.

(51) Int. Cl. G06Q 40/00

(52) U.S. Cl. 705/35

(57) ABSTRACT

A system and method for assessing a financial institution's capital risk. The method includes the steps of receiving financial information, processing the financial information to obtain a scenario for capital risk, assigning one of a number of predetermined rating categories to the financial institution according to the scenario, applying one or more secondary filters pertaining to additional risks selected by a state regulator to adjust the assigned rating category, and displaying the scenario and the adjusted rating category on a display device.

### CROSS REFERENCE TO RELATED APPLICATIONS

This application is a continuation-in-part of U.S. patent application Ser. No. 12/849,744 filed on Aug. 3, 2010, which claims priority from U.S. Provisional Application No. 61/230,906 filed on Aug. 3, 2009, each of which is incorporated by reference in its entirety herein. This application further claims priority from U.S. Provisional Application No. 61/299,711 filed on Jan. 29, 2010, which is incorporated by reference in its entirety herein.

### FIELD OF THE INVENTION

The system and method of the present disclosure relates to a computer-based system and method for assessing, quantifying, and presenting the capital risk of a financial institution, and in particular, assessing, quantifying and presenting the capital risk in a manner that is meaningful to state and/or other affected government regulatory agencies.

### BACKGROUND OF THE INVENTION

Financial institution modeling tools are inherently complex, relying on balance sheet data to create profits and loss projections. The earnings on assets and the costs of liabilities may be tied to specific market rates which in turn have a complex relationship with each other and as a whole are affected by market liquidity. Traditional tools for financial institution modeling may apply a “bottom up” approach requiring a highly complex series of assumptions to ensure that appropriate rates have a proper, consistent and realistic relationship with each other. But given the sensitivity of these intricate inter-rate relationships, the impact on the financial institution's performance caused by individual rate increases can be distorted and highly misleading. An extremely large number of iterations and scenarios may be required for a traditional, pre-recession financial institution model to accurately reflect realistic economic simulations. In all of them, the inter-rate relationships must be carefully crafted beyond traditional modeling capabilities. The fragility of these constructs thus makes them less reliable and useful as the organization finds itself more distant from “normal” economic times. Another reason these models are of limited use in an unstable economy is due to the impact on the financial institution's survivability (and on stress-testing) as a function of profitability is relatively long-term, minimal, and benign compared to the impact from changes in the balance sheet. Traditional asset liability models and capital adequacy tests (such as Basel) are either inefficient (because they are based on generic, applied cumulative ratios) or limited (because their testing of segregated asset categories in relative isolation from one another hampers the measurement of their cumulative impact on capital adequacy). In reality, as noted, assets and liabilities are affected in varying degrees by a range of common, well-known vulnerabilities that, taken together, have a net cumulative impact on the financial institution's balance sheet. It is this net cumulative impact that may be measured and analyzed by financial institutions, regulators, investors and D&O underwriters, taking into account their unique operating and financial environments. Unlike those previous models, the system and method of the present disclosure may monitor, assess, quantify and present a financial institution's capital risk, from either a historical or forward-looking perspective.

### SUMMARY OF THE INVENTION

The present invention is directed to a computer based system and method for assessing a financial institution's capital risk. The method includes the steps of receiving financial information, processing the financial information to obtain a scenario for capital risk, assigning one of a number of predetermined rating categories to the financial institution according to the scenario, applying one or more secondary filters pertaining to additional risks selected by a state regulator to adjust the assigned rating category, and displaying the scenario and the adjusted rating category on a display device.

### BRIEF DESCRIPTION OF THE DRAWINGS

FIG. 1 presents a Residential Real Estate Open End Portfolio analysis of a financial institution's capital at risk comparing a baseline scenario and stressed scenario.

FIG. 2 presents a table of a Summary of Provision Analysis by Portfolio containing a list of the types of loans by a financial institution and summarizes the portfolio under a stress test scenario.

FIG. 3 is a flow chart for calculations of the financial institution's capital risks.

FIG. 4 is a data flow chart for calculations of the Loss Regulatory Capital at the Enterprise Level.

FIG. 5a presents a three dimensional topographical chart of the Loss of Regulatory Capital.

FIG. 5b presents a three dimensional topographical chart of the Net Cumulative Impact on Tier 1 Capital Ratio.

FIG. 6 presents a summary of Tier 1 Capital rating categories and Secondary Filters applied to prepare a final Tier 1 Capital rating for an exemplary financial institution according to aspects of the system and method of the present disclosure.

FIGS. 7a-7p further describe the Secondary Filters of FIG. 6.

FIGS. 8a-8m presents an exemplary report prepared according to aspects of the system and method of the present disclosure.

FIG. 9 presents another exemplary report prepared according to aspects of the system and method of the present disclosure.

FIG. 10 presents an exemplary system architecture consistent with aspects of the system and method of the present disclosure.

FIG. 11 present an exemplary database management (DBM) architecture for use in the system architecture of FIG. 9.

FIG. 12 is a schematic diagram of a computer system suitable for executing the operations described in the exemplary architecture of FIG. 10.

### DETAILED DESCRIPTION OF THE INVENTION

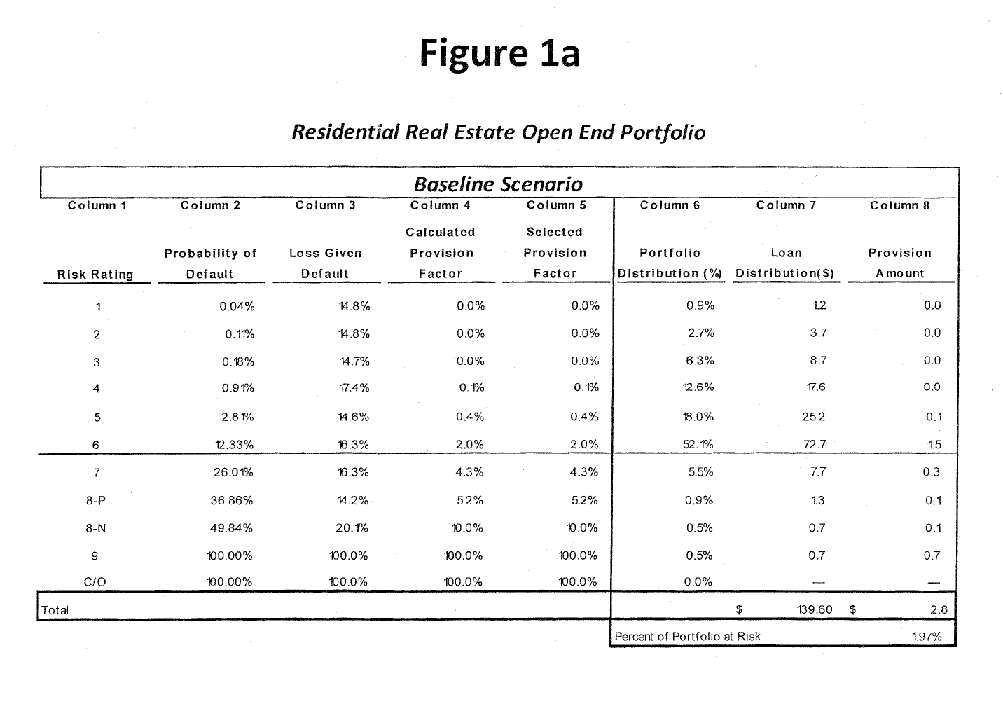

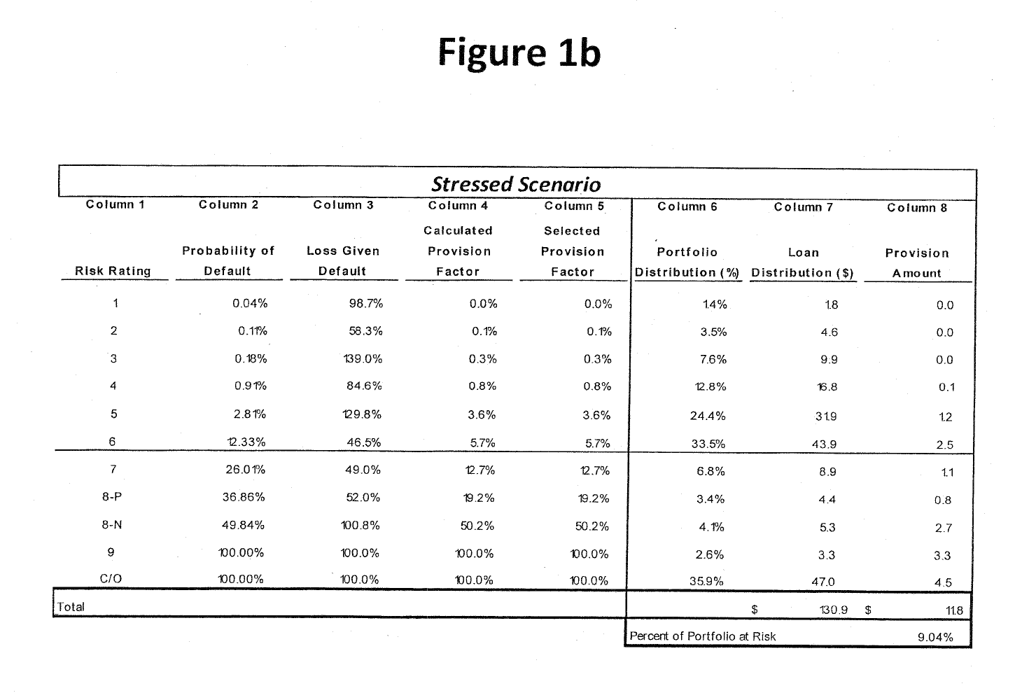

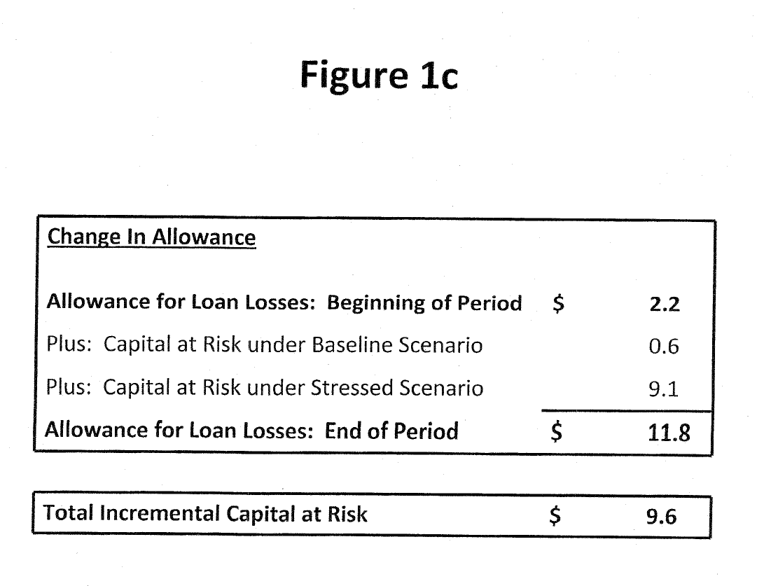

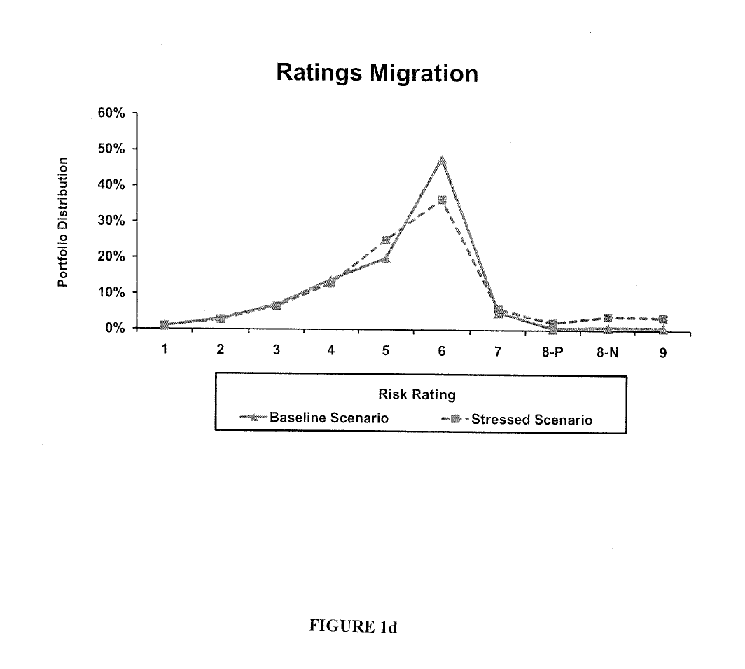

The system and method of the present disclosure may overcome the limitations of previous financial institution modeling tools by recalculating a financial institution's current or projected regulatory capital position without over-reliance or bias on financial data reported by the financial institution's management. More specifically, the computer based system and method of the present disclosure assesses a financial institution's capital risk by calculating current or historical baseline scenarios which recalculate a financial institution's regulatory capital position for a current or historical period and comparing the baseline scenario with regulatory capital and loan loss figures actually reported by management. FIG. 1 is representative of one aspect of the present invention displaying a financial institution's capital risk by calculating baseline scenarios (FIG. 1a) and stressed scenarios (FIG. 1b) within a loan category and comparing the two scenarios to determine the financial institution's total incremental capital at risk.

Each asset and/or liability may be assigned one or more characteristics, such as borrower repayment risks, loss characteristics, and black-swan era specific risks. Borrower Repayment Risks may include Debt Service Coverage, Liquidity, Capital Structure/Leverage, Access to Additional Capital, and Balloon Payments at Maturity. Loss Characteristics may include Underwriting Assumptions, Collateral Values, Collateral Position, Recourse/Non-Recourse, Derivatives, Other Enhancements, Access to Secondary Markets, and Counterparty Risk. Black-Swan Era Specific risks may include Maturity within 2 years, Mismatched structure to performance, Modifications due to changes in performance, and Contingent Exposure.

FIG. 1a shows a “Baseline Scenario” with eight columns. The first column, “Risk Rating” has eleven categories labeled from 1 to C/O (Charge-Offs). For each risk rating, there is a corresponding column titled, “Probability of Default”. The third column is represented as “Loss Given Default”. Multiplying the loss given default with the probability of default results in a “Calculated Provision Factor” found in column four. In the event the user wants to override the calculated provision factor, he/she can do so by manually entering another provision factor. The final provision factor is referred to as the “Selected Provision Factor” column five. Column seven is the “Loan Distribution” amount for each risk rating category with its corresponding “Distribution Percentage” found in column six. The loan distribution amount is equal to the principal amount of loan for each corresponding risk rating. The “Provision Amount” appearing on the last column is the result of multiplying the selected provision factor with the loan distribution amount. The total provision amount is divided by the loan distribution amount to determine the “Percentage of the Portfolio at Risk” as illustrated in the last row in FIG. 1a.

FIG. 1b shows a “Stressed Scenario” with columns numbers corresponding to the baseline scenarios of FIG. 1a. A stressed scenario represents what the same loan portfolio could look like in a future period (i.e. one-year, two-years, three-years, etc). Comparison of the stressed scenario against baseline scenario of FIG. 1a, results in the increase in the loss given default percentages in the stressed scenario. The loan portfolio of the stressed scenario has been redistributed to reflect increases in non-performing loans and the corresponding weaker risk ratings as specified by the user. The combination of loan portfolio redistribution and increases in loss given default rates causes a corresponding increase in the provision amount. The last row in the stressed scenario labeled as “Percent of Portfolio at Risk” shows the increased amount of the portfolio at risk.

The system and method of the present disclosure may calculate the changes in key categories/variables/regulatory targets caused by the impact of specified stresses acting on appropriately defined characteristics of assets and liabilities.

Stresses may include, but are not limited to, Economic Activity, which may include GDP, Capacity Utilization, Commercial Durable Goods, and New Home Starts; Inflation Risk which may include Commodity Prices, Foreign Exchange, and CPI Index; Interest Rate Risk which may include LIBOR, Prime, Res. Mortgage, and TED Spread; Market Liquidity which may include Commercial Credit Availability, Consumer Credit Availability, Secondary Market Liquidity, and Stock Market; Repayment Risk which may include Commercial Default Rates, and Consumer Default Rates; Unemployment Rate which may include Short-term Changes, Longer-term trends, and Comparable Metrics; Appraisal Values which may include Home Prices, Commercial, and Consumer; Consumer Spending which may include Farm Income, Gas Prices, Consumer Durable Goods, Non-Durable Goods, Net Disposables, Retail Sales, and Savings Rate.

The impact of each stress on each characteristic as it applies to the appropriate assets and liabilities on the balance sheet may be isolated and quantified. External information used in determining stress may include macro and micro econometric data on a global, national or regional basis as appropriate to the specific institution or institutions under analysis.

The system may in addition display a net cumulative impact of stresses on appropriate target criteria ranging from institutional regulatory capital to actuarial capital requirements to corporate market debt ratings. Changes may be made to the input data and some or all of the process may be re-executed to show corresponding output changes.

For example, FIG. 1c calculates the “Total Incremental Capital at Risk” based on the data accumulated from FIG. 1a and FIG. 1b. One aspect of this data is derived from “Capital at Risk Baseline Scenario” which is the result of subtracting “Allowance for Loan Losses: Beginning of Period” from the total provision amount under the baseline scenario of FIG. 1a. Similarly, “Allowance for Loan Losses for the Beginning of the Period” is subtracted from the total provision amount in the stressed scenario of FIG. 1b resulting in “Capital at Risk under Stressed Scenario”. Calculation of the “Total Incremental Capital at Risk” is determined by subtracting the “Allowance for Loan Losses: Beginning of Period” from the “Allowance for Loan Losses: End of Period”. The total incremental capital at risk is then summed for each loan category, and the final total incremental capital at risk is deducted from the financial institution's reported regulatory capital from the current period to estimate the financial institution's post-stress regulatory capital position before consideration of pro forma earnings or losses.

FIG. 1d is a “Ratings Migration” graph comparing the risk rating in the baseline scenario against the stressed scenario in a portfolio. FIG. 1d further illustrates that when a portfolio is stressed, there is a shift in the distribution to loans with higher risks.

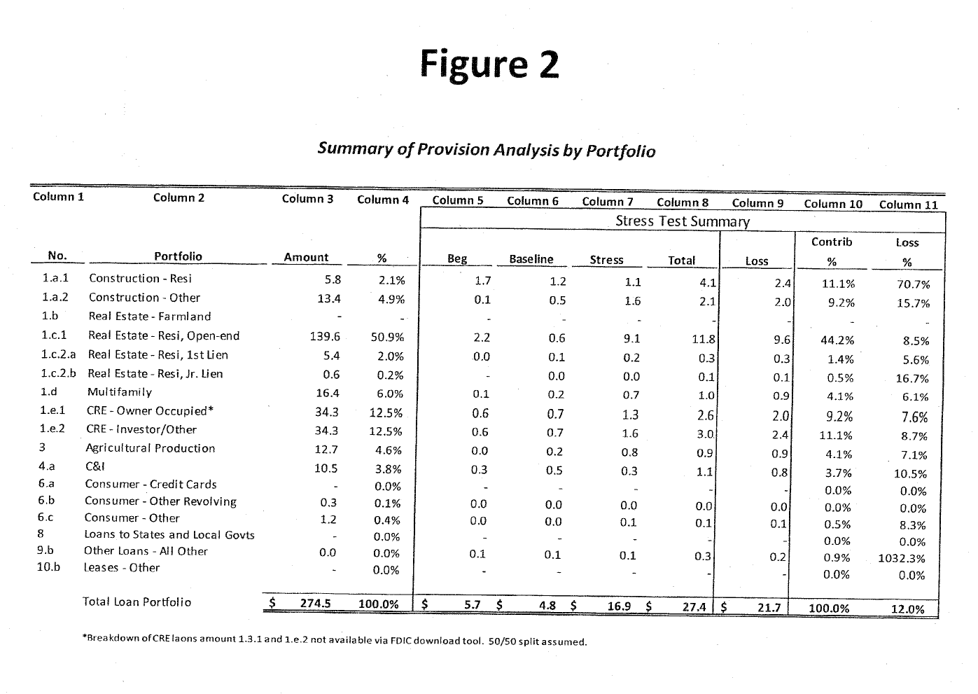

FIG. 2 is representative of another aspect of the present invention displaying a table summary of a financial institution's capital at risk by loan categories, with columns numbered 1 through 11. Column two represents examples of individual loan categories present in a financial institution's loan portfolio with the corresponding principal amount of the loan represented as a dollar (column 3) and percentage amount (column 4) for each loan category. Immediately to the right of column four is a “Stress Test Summary” for each loan category. The column titled “Beg” in column five corresponds to the allowances for loan losses for the beginning of the period. Column six titled “Baseline” represents the capital at risk for each loan category under a baseline scenario. Column seven titled “Stress” represents the capital at risk for each loan category under a stressed scenario. The “Total” column represents the total “Allowance for Loan Losses for the End of the Period”. Column nine labeled as “Loss” represents the total incremental capital at risk for each loan category. The “Loss” column is calculated by subtracting allowance for loan losses at the beginning of period (column 5) from allowance for loan losses for the end of the period (column 8). Column 10 labeled as “Contributory %” is equal to the loss amount for each loan category divided by the total to determine what loan categories are contributing to the financial institution's total loss. “Loss %” found in column 11 is determined by dividing the loss from column 9 by the principal amount in column 3 to determine the percentage of the loan portfolio affected by the applied stress. The last row in the table labeled “Total Loan Portfolio” represents the sum for each corresponding column discussed above.

The method of the present disclosure can be practiced by receiving financial information from public sources such as S&P, FDIC, SNL and other providers of call report data and/or from the financial institution's own propriety information database. The financial institution's propriety information may include total amount of loans outstanding, non-performing loans, overdue loans, maturity schedule, existing regulatory capital levels, existing loan loss reserve amounts and risk weighted assets. The information is then processed with the results of a financial institution's capital risk presented as comprehensive, detailed and easily understandable output data.

An exemplary aspect of the present disclosure is detailed below for estimating a financial institution's loan reserves as of the current or historical period by separating the financial institution's loan portfolio into distinct loan categories, performing calculations at the loan category level and performing calculations at the enterprise level. Calculations at the enterprise level include summation of all of the loan categories, plus other adjustments for earnings, dividends, etc.

The method of the present disclosure may estimate the financial institution's future regulatory capital position based on certain user modifications. No limitations are placed as to the order of the steps for practicing the present invention after receiving financial information from public sources or from the financial institution's propriety information database. Each of the representative steps of the present disclosure is described to enable one aspect of the practice of the present invention and should not be construed to limit the disclosure of the invention to those aspects described.

Loan categories may include, but are not limited to loans for: construction residential, construction—other, real estate—farmland, real estate—residential, open—end, real estate—residential, first lien, real estate—residential, junior lien, multifamily, Commercial Real Estate (“CRE”)—owner occupied, CRE—investor/other, agricultural production, Commercial and Industrial (“C&I”), consumer—credit cards, consumer—other revolving, consumer—other, loans to states and local governments, other loans—all other, leases—other. For each loan category described above, assumptions may be input into the present disclosure to estimate the financial institution's loan loss reserves as of the current or historical period. Assumptions under the system and method of the present disclosure may include the size and the structure of the risk rating system, risk rating distribution, probability of default, loss—given default, provision factor overrides, fate of maturing loans, increases in non performing loans, increases in criticized/classified loans.

Each financial institution has its own internal system for rating each loan that it makes. Rating systems are based on the risks associated with a loan. Risk rating systems differ among financial institutions, where larger financial institutions may use a 20-point risk rating system and smaller financial institutions may use a 4-point risk rating system. The risk rating system that a financial institution uses is not typically publicly available. One aspect of the system and method of the present disclosure assumes and applies a 10-point risk rating system across the universe of financial institutions, with a “1” rating being the best rating a loan can receive, and a “10” rating being the worst. The rating system can easily be expanded or contracted on a customized basis.

For each of the loan categories, the distribution of a loan portfolio may differ. For example, construction loans may be riskier than and therefore may have a higher risk rating than a first lien residential real estate mortgage. The user of the system and method can determine the distribution of a loan category, by percentage, across the rating system.

For each risk rating class, the user of the system and method can determine the probability of a loan assigned that rating of defaulting, known as Probability of Default (PD). Inherently, the higher the rating, the lower the probability of default. For example, the user can specify that a “1” rated loan has a 0.01% chance of defaulting, while a loan rated a “9” has a 75% chance of defaulting.

For each risk rating class, the user of the system and method can determine the loss the financial institution will realize on the loan, in the event the loan defaults, known as Loss Given Default (LGD): For example, if financial institution A underwrote a $1 M loan, and the loss-given default (LGD) rate of that loan is 60%, then the LGD amount is $600 k (equal to $1 M multiplied by 60%).

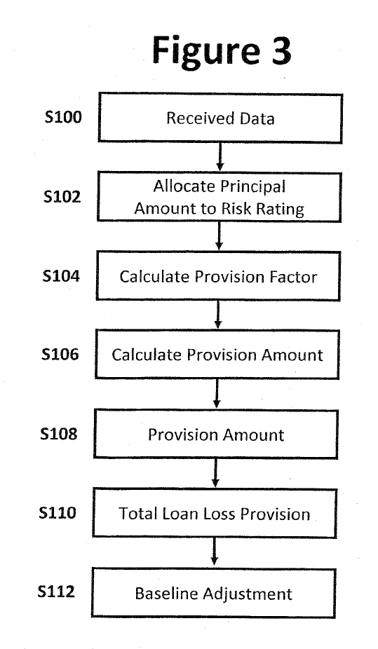

As set forth in FIG. 3, once the financial institution data is received and the above—parameters set (Step S100), the system and method of the present disclosure may then perform the following calculations at the loan category level.

In Step S102, the principal amount outstanding for each loan category is allocated to the Risk Rating System created by the end user by multiplying the principal amount by the rating distribution assumptions for each risk rating class. Example 1, if financial institution A has $100M of Construction—Residential Loans, and the user of the system and method selected a 10-point risk rating system, and assumed that 20% of Construction-Residential Loans are rated a “5”, then the system and method calculates that financial institution A has $20M ($100M×20%) of “5” rated Construction Residential Loans.

In Step S104, the assumed Probability of Default rate is multiplied by the assumed Loss—Given Default rate for each risk rating class for each loan category to calculate the Provision Factor. In our example, if the user assumed the probability of default rate and loss given default rate for “5” rated Construction Residential Loans was 10% and 40% respectively, the Provision Factor is equal to 4% (10%×40%). In one aspect, the end user of the system and method may override the calculated provision factor with a manual percentage.

In Step S106, the estimated principal amounts for each risk rating class for each loan category are then multiplied by its respective Provision Factor to calculate the Provision Amount (Step S108). In the ongoing example, the amount that the system and method estimates financial institution A should provision for “S” rated construction-residential loans is $800 k (equal to $20 M times 4%).

Steps S102 through S108 may be repeated for each risk rating class. The Provision Amounts for each risk rating class are summed for each loan category. Calculations at the enterprise level include summing the subtotal provision amounts for each loan category to estimate the total Loan Loss Provision.

In Step S110 of FIG. 3, the total estimated loan loss provision is compared to the reported loan loss provision by the financial institution. The variance is referred to as the “Baseline Adjustment” (Step S112).

If the estimate is greater than the provision reported by the financial institution, then the variance represents a pro forma incremental loss of regulatory capital for the current period. The larger the unfavorable variance, the more of an indication that the financial institution is under provisioned, given the user of the system and method's assumptions.

If the estimate from the system and method is less than the provision reported by the financial institution, then the variance represents a pro forma incremental gain of regulatory capital for the current period. The larger the favorable variance, the more of an indication that the financial institution is over-provisioned, given the user of the system and method's assumptions. Whether the financial institution is over or under-provisioned is important information and may be communicated to the financial institution in various forms as described in more detail below.

The system and method of the present disclosure may also estimate a financial institution's future regulatory capital position by applying the calculations outlined in the steps above with the following potential modifications by the user: assuming a different rating distribution for each loan category, assuming the distribution of the fate of maturing loans and the estimated loan loss provisions are recalculated for maturing loans for each loan category, or assuming different probability of default rates or loss given default rates.

The system also allows the user to allocate the Incremental Loss of Regulatory Capital for each loan category to a series of external factors. Factors attributed to user assumptions include positive or negative external factors which may include, but are not limited to, economic activity, which may include gross domestic product (GDP), capacity utilization, commercial durable goods, and new home starts; inflation risk which may include commodity prices, foreign exchange, and CPI Index; interest rate risk which may include LIBOR, prime, residential mortgage, and the difference between the interest rates on interfinancial institution loans and short term U.S. government debt (commonly known as the “TED” Spread); market liquidity which may include commercial credit availability, consumer credit availability, secondary market liquidity, and stock market; repayment risk which may include commercial default rates, and consumer default rates; unemployment rate which may include short-term changes, longer term trends, and comparable metrics; appraisal values which may include home prices, commercial, and consumer; consumer spending which may include farm income, gas prices, consumer durable goods, non-durable goods, net disposables, retail sales, and savings rate. As defined herein, the term “stress” represents negative external factors however; the present invention can also assess a financial institution's capital risk in an environment with positive external factors i.e. in an economic recovery scenario.

Modifications based on a different rating distribution for each loan category. For example, if the user believes that the financial institution is facing a negative future, it can redistribute the distribution percentages for a loan portfolio to be more heavily-weighted towards the lower risk rating classes. The user can do this by increasing the percentage of non-performing loans and/or the percentage of criticized/classified loans.

Modifications based on a distribution of the fate of maturing loans, and the estimated loan loss provisions are recalculated for maturing loans for each loan category. For example, a loan that matures prior to the future period selected by the user can experience one of the following fates: The loan is paid in full by the borrower, and the financial institution chooses not to relend the funds. The Loan is paid in full by the borrower and the financial institution chooses to relend some or all of the funds to new borrower(s) with specified risk rating(s), and with specified LGD rate(s). The Loan is “rolled over”—i.e. the financial institution chooses to renew the loan with the same borrower, and the funds are not paid back in fall, but the risk rating of the loan does NOT change. The Loan is modified because there are problems with the loan or the risk of the loan has increased. This results in a downgrade of the rating of the loan. The Loan defaults and the financial institution take steps to seize the collateral or collect the principal from the borrower under difficult conditions.

Different probability of default rates or loss given-default rates can be assumed by the end user of the system and method, based on the user's expectation of the future. For example, if the user of the system and method assumes a negative economic environment for a certain type of loan or industry, he/she can increase the loss given default rate to reflect the decreased valuations of the collateral.

The user can add the following adjustments to the future estimate of regulatory capital for the financial institution such as the impact of earnings/losses from the financial institution's operations, dividends, impairments to non-lending assets such as the securities portfolio, goodwill, capital raises and asset sales.

To determine the impact of earnings/losses from the financial institution's operations, the system and method may consider at the financial institution's “run rate” profit and losses, and makes the following adjustments by calculating the marginal loss of interest income yields or incremental anticipated expenses such as: Loss of revenues from performing loans that get reclassified to non performing risk rating classes. Loss of revenues from maturing loans that get paid off in full, and are not relent by the financial institution changes in interest rates. Incremental losses from expenses associated with foreclosed assets (i.e. OREO expenses). Marginal costs associated with the financial institution's liabilities (i.e. brokered funds) and changes to the financial institution's fixed costs or overhead.

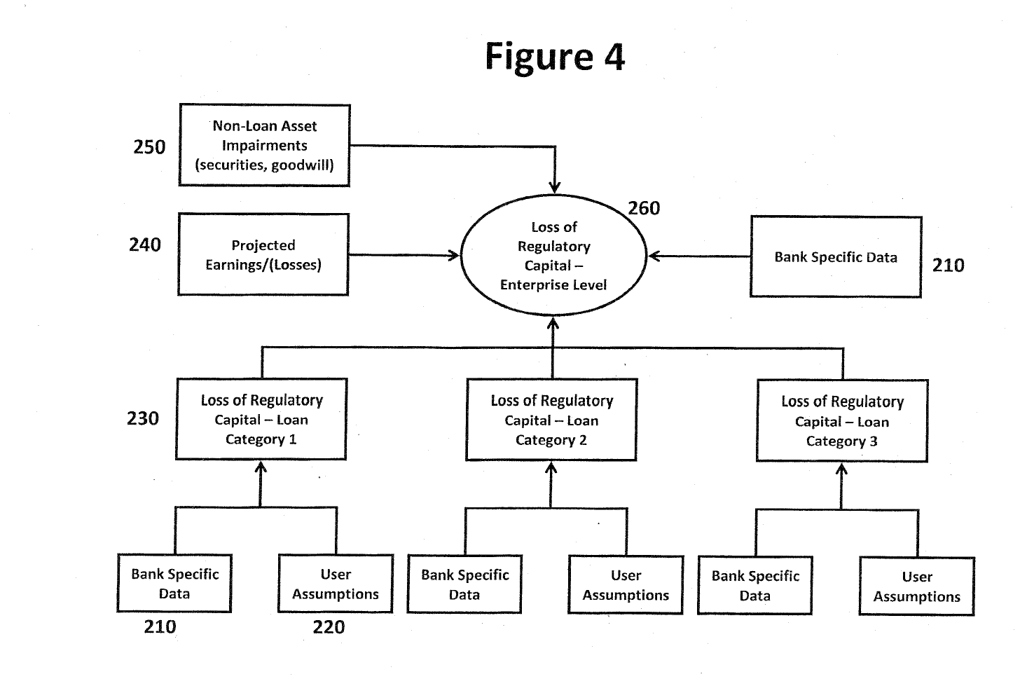

Another aspect of the present disclosure is illustrated in FIG. 4 which shows a data flow chart for determining Loss of Regulatory Capital at the Enterprise Level. Loan categories (230) are identified. User assumption (220) and financial institution specific data (210) are applied to each loan category (230) as described above. The loan categories are summed and factored along with the financial institution's projected earnings/losses (240), non—loan asset impairments (250) and financial institution specific data (210) to generate a loss of regulatory capital at the enterprise level (260).

The system and method of the present disclosure further includes an output presentation of the present disclosure to facilitate the analysis and review of the results. Changes may be made to the input data and some or all of the processes may be re-executed to show corresponding output changes. Any output information generated may be printed, displayed on a display, or provided electronically in the form of HTML, flat files, PDF, SharePoint, Excel, and BI & data mining applications. The output data can be in the form of tables, charts, diagrams that are comprehensive and easily understandable by industry participants or non industry participants. Those contemplated to benefit from the present invention are financial executives, directors, managers, regulators, investors, insurers and any parties interested in identifying a financial institution's financial health.

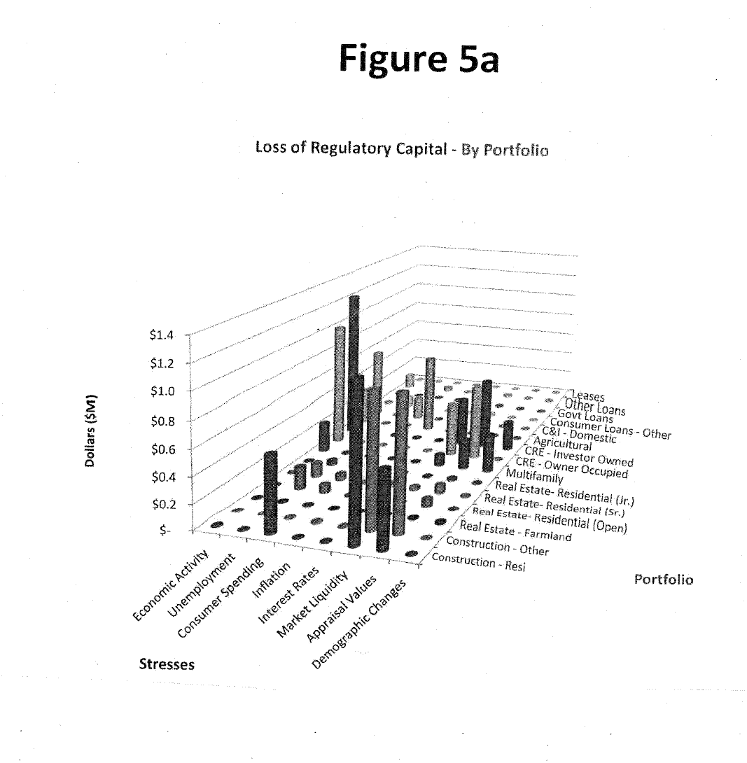

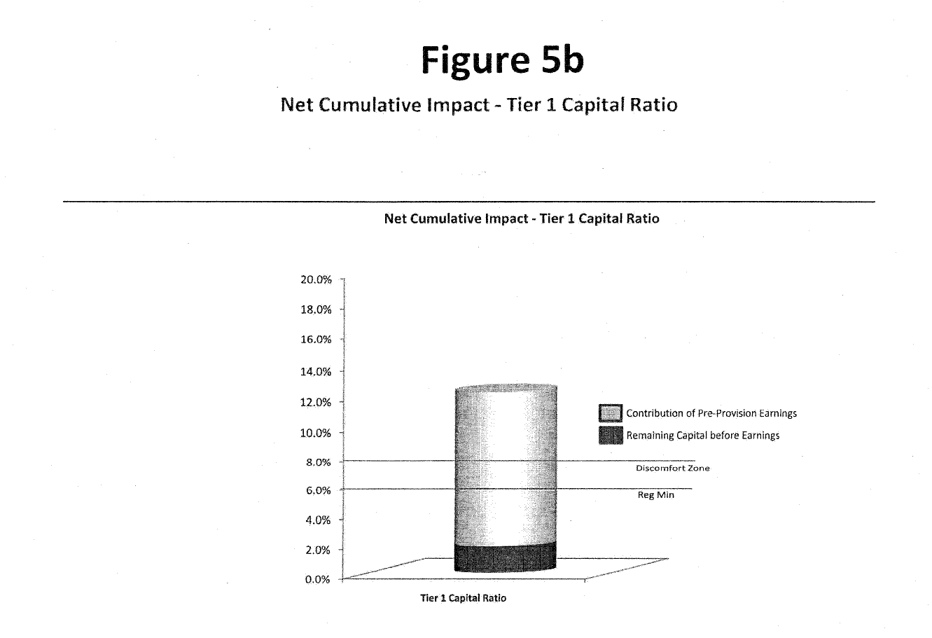

One aspect of the present invention is displayed in the output data shown in FIG. 5a of a three dimensional topographic chart of the loss of regulatory capital where, the loss of regulatory capital is represented as dollar values along the Y axis, attributed to specific stress along the X axis, and portfolio along the Z axis. The heights of the graphic “dowels” reflect the loss of regulatory capital from the impact of stresses on the specified portfolio category.

Another aspect of an output of the present disclosure is illustrated as FIG. 5b of a three dimensional topographic chart of the Net Cumulative Impact-Tier 1 Capital Ratio. The chart is illustrative of a bank's capital health. The vertical axis represents the financial institution's Tier 1 Capital Ratio. A lower horizontal line represents the “Regulatory Minimum” of Tier 1 capital ratio required under government regulations and is the minimum capital required to avoid financial institution shut down by the regulatory authorities. An upper horizontal line delineates the “Discomfort Zone” which is the minimum capital necessary above the regulatory minimum for the financial institution to be considered in a comfortable financial position. Both the regulatory minimum amount, and the discomfort zone amount can be determined by the user. If a financial institution has more capital than the regulatory minimum amount, but less than the discomfort zone amount, the financial institution is in the discomfort zone. The area labeled as “Remaining Capital Before Earnings” represents the stressed scenario excluding earnings. “Contribution of Pre-Provision Earnings” represents offsets as illustrated by contributions from non-loan asset impairments (250) and projected earnings/(losses) (240) into the loss of regulatory capital-enterprise level (260) in FIG. 4. Contribution of pre-provision earnings can positively or negatively contribute to determining the health of the financial institution. In this particular example, there is no contribution of pre-provision to the analysis. In summary, FIG. 5b illustrates that the financial institution is reporting 13% of capital levels where levels above 8.0% (above the discomfort zone) is considered financially “healthy” for the institution. In a stressed scenario, where the bank's assets are stressed, the bank's remaining capital before earnings is estimated to be approximately 2%, much lower than the regulatory minimum required. Thus, the representative graph illustrates a risky financial institution under a stressed scenario in contrast to its reported financial information.

In accordance with aspects of the system and method of the present disclosure, it may be helpful to provide a rating system and method that enables interested parties, including for example state and other affected government regulators, to compare Tier 1 Capital Ratios for a population of financial institutions. FIG. 6 shows an example overview of aspects of the such a system and method including, but not limited to, a method of presentation.

In FIG. 6, an example rating scheme is presented as SIBIL rating categories 1 through 5. In this case, for example, rating categories 1 and 2 are assigned to financial institutions (banks) falling within the top and second quartiles, respectively, with regard to 2-year post stress Tier 1 Capital Rankings Rating category 5 is assigned to all banks having regulatory capital that falls below the minimum regulatory Tier 1 Capital position, and rating category 4 is assigned to all banks having regulatory capital that would have fallen below the minimum regulatory Tier 1 Capital position without the benefit of the earnings component of the capital. All other banks are assigned to rating category 3.

By basing rankings on Tier 1 Capital performance, as described supra, the rankings provide a measure of financial performance which focuses on asset performance and the sustainability of capital under economic stress. In addition, and in accordance with additional aspects of the system and method of the present disclosure, it may be helpful to adjust the above-described ratings according to additional factors that could, for example, impact the safety and soundness of a bank's performance.

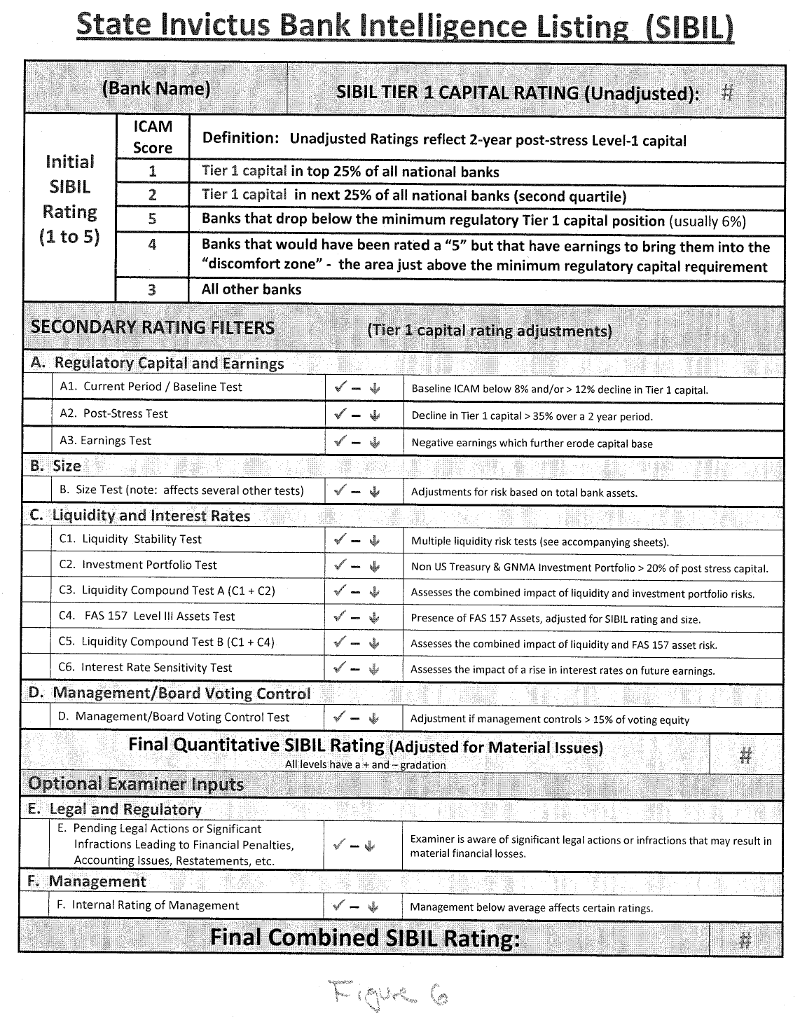

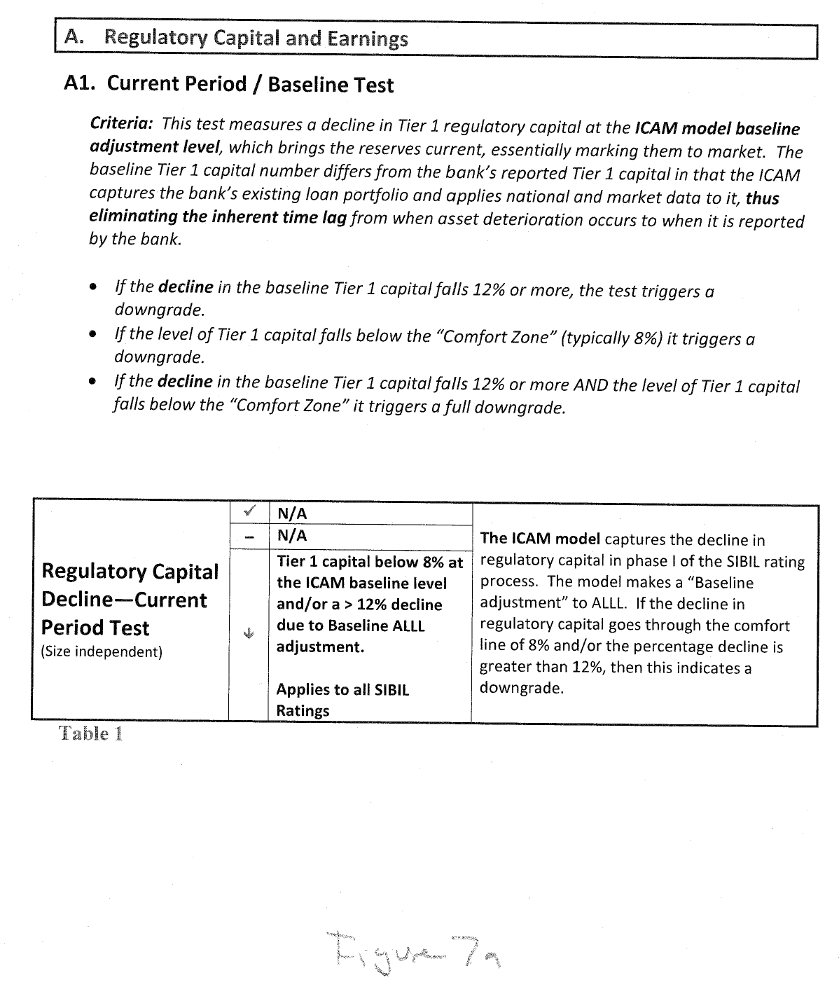

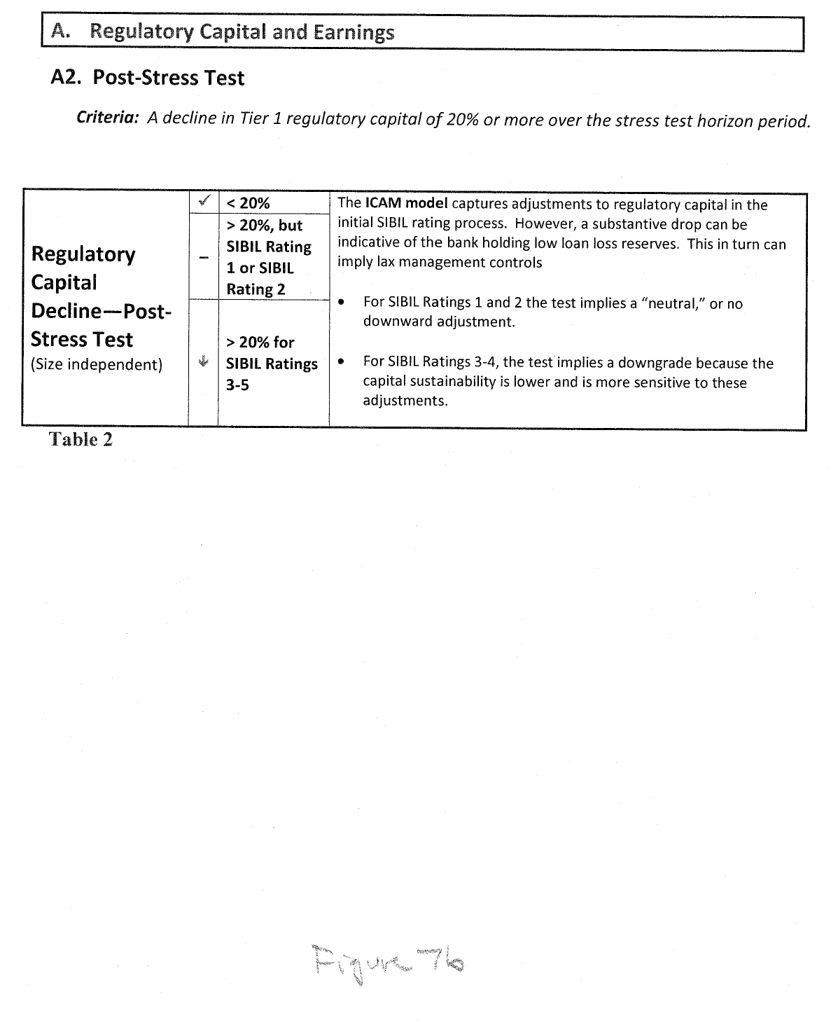

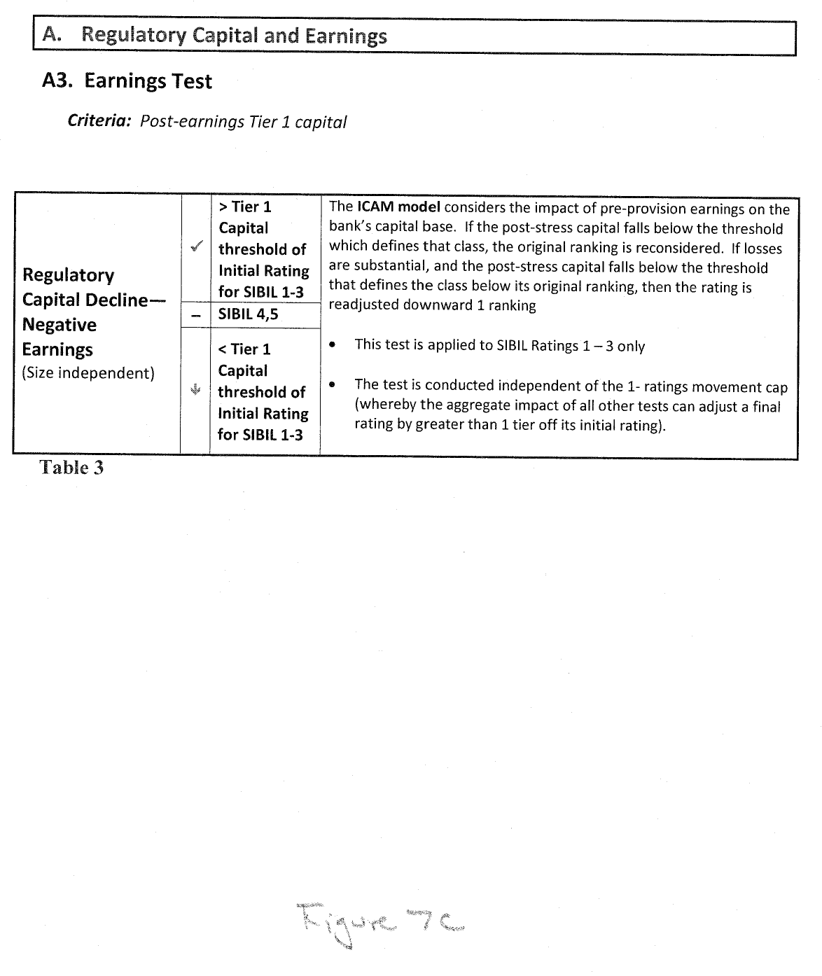

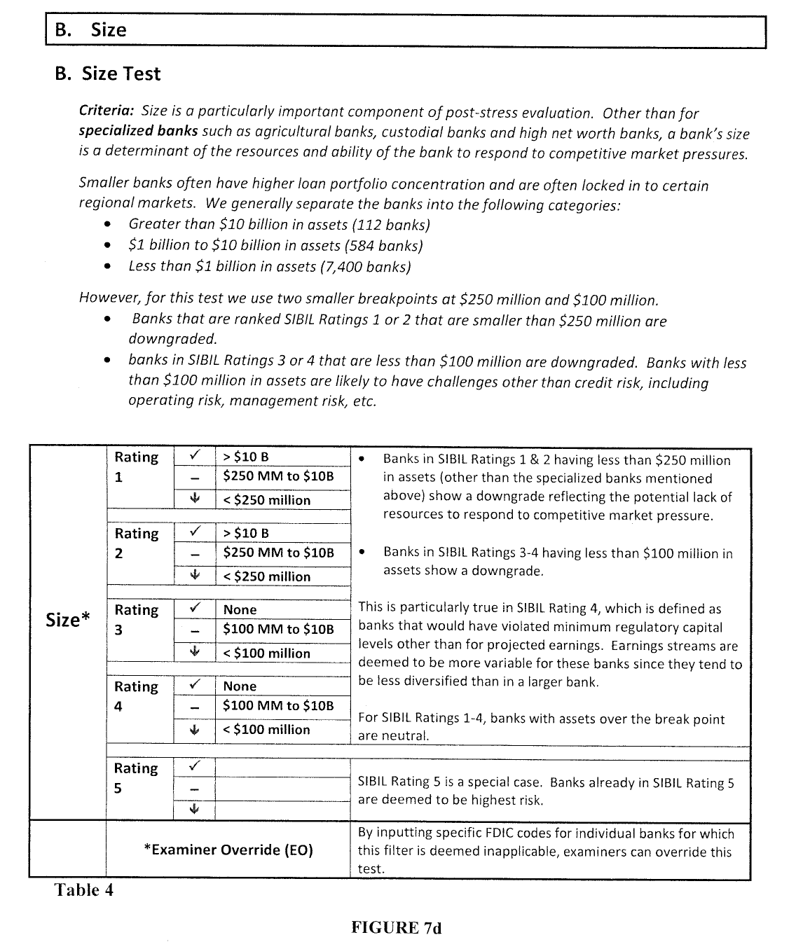

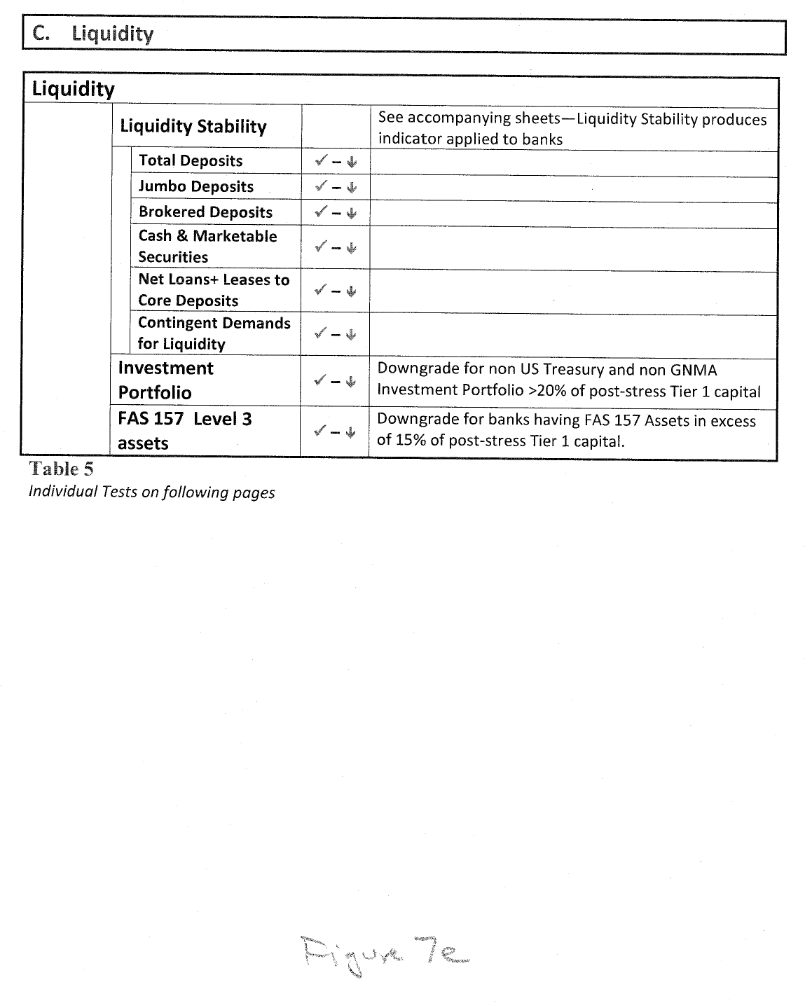

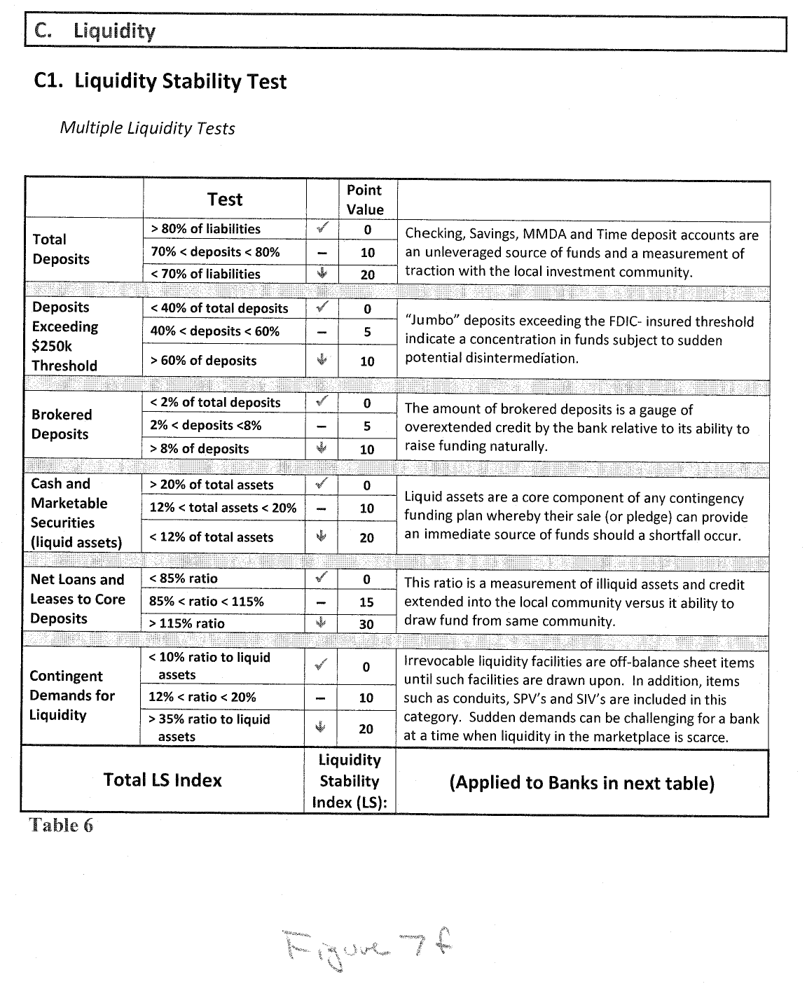

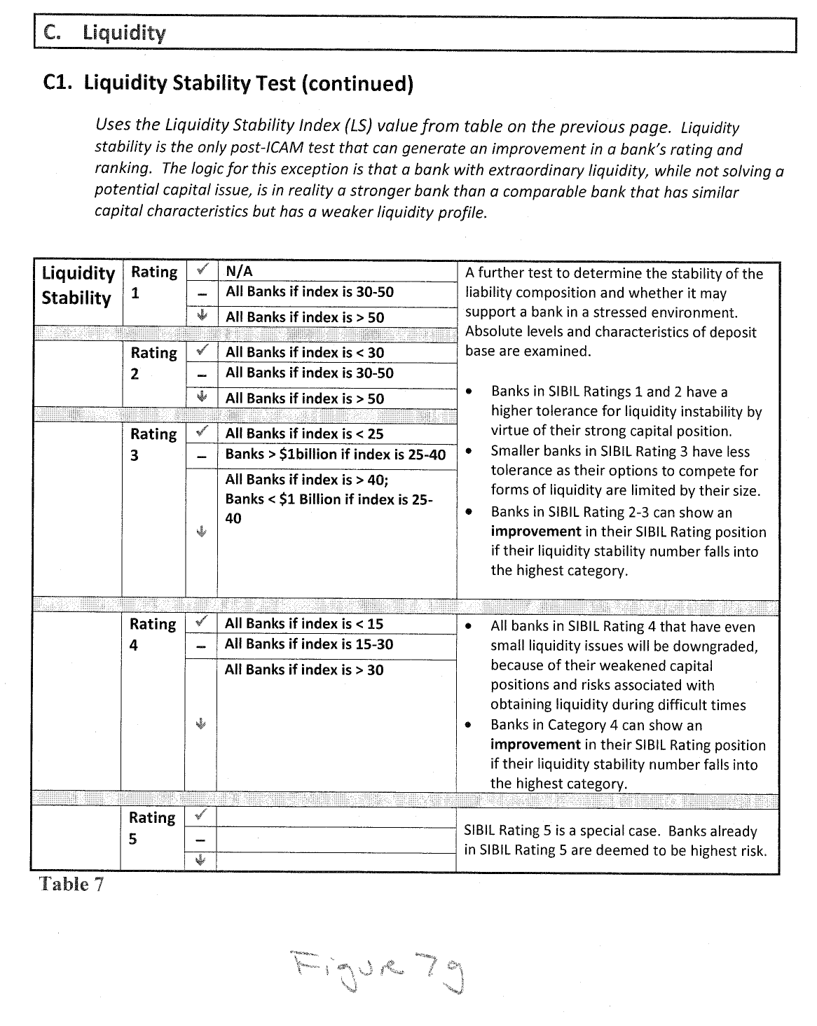

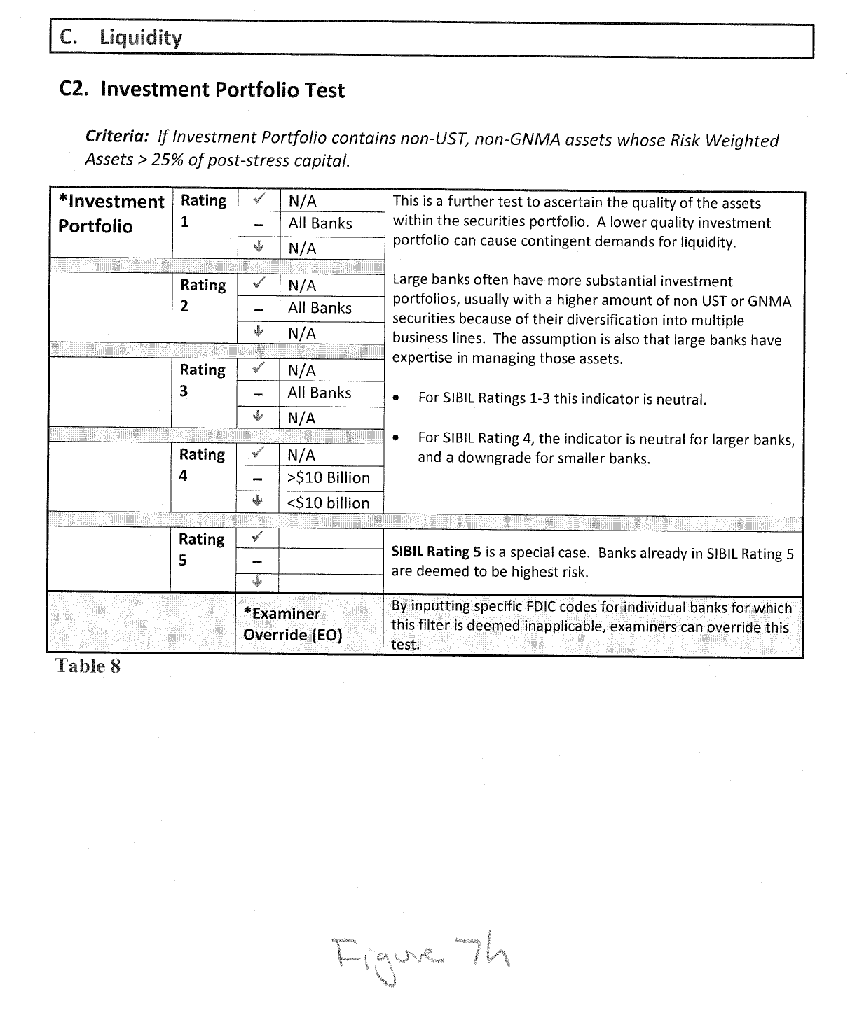

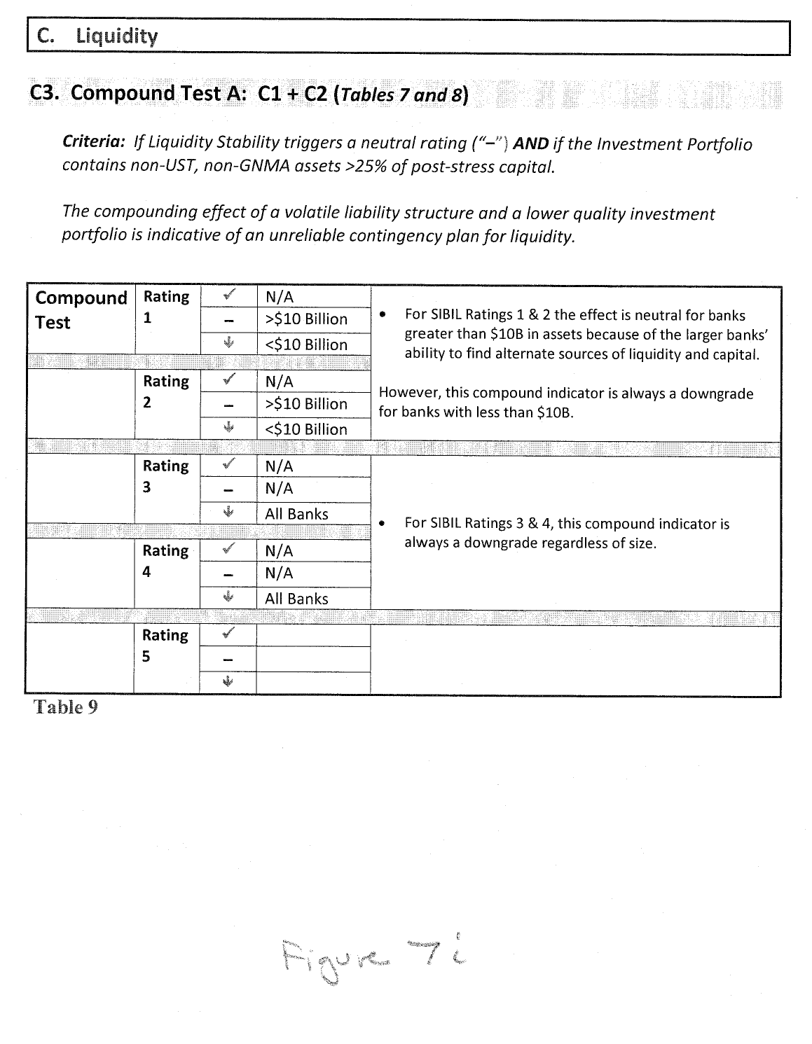

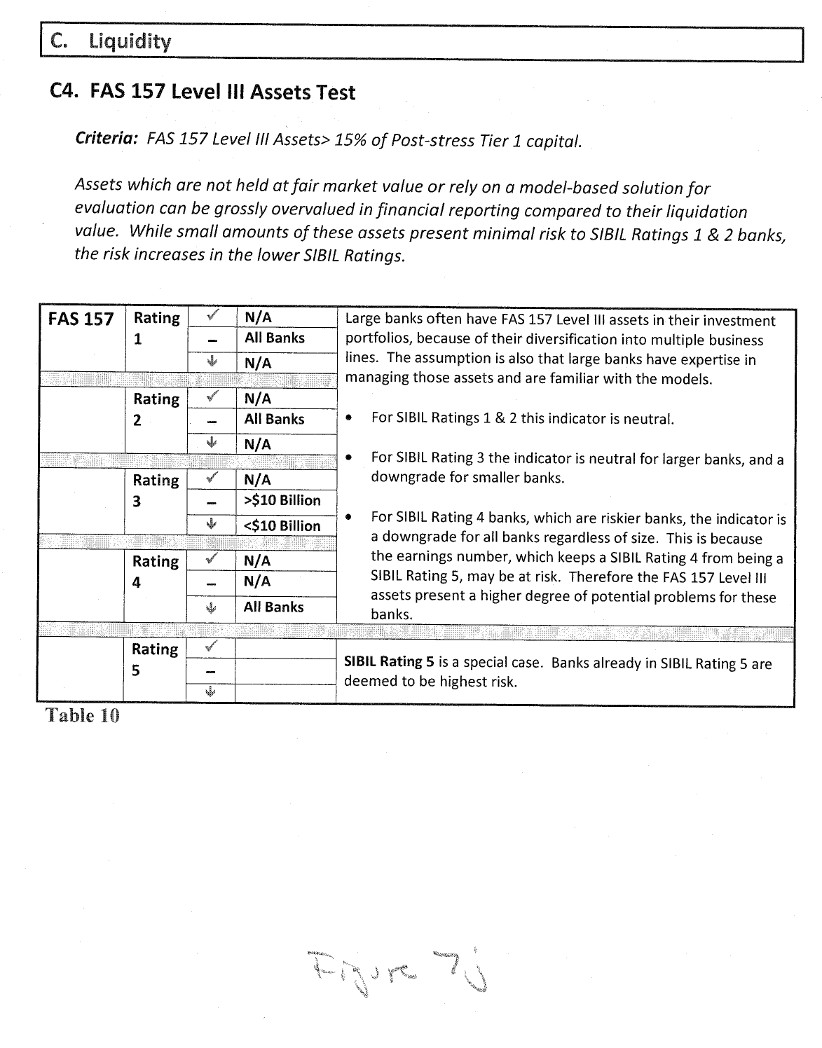

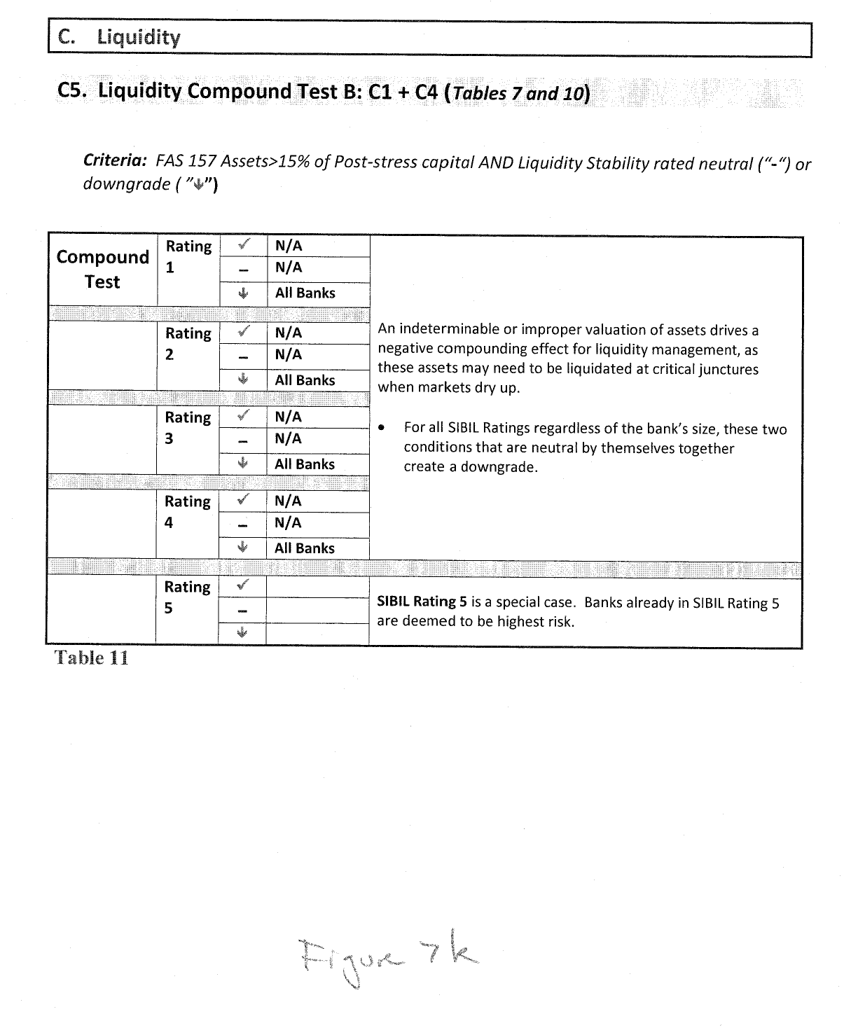

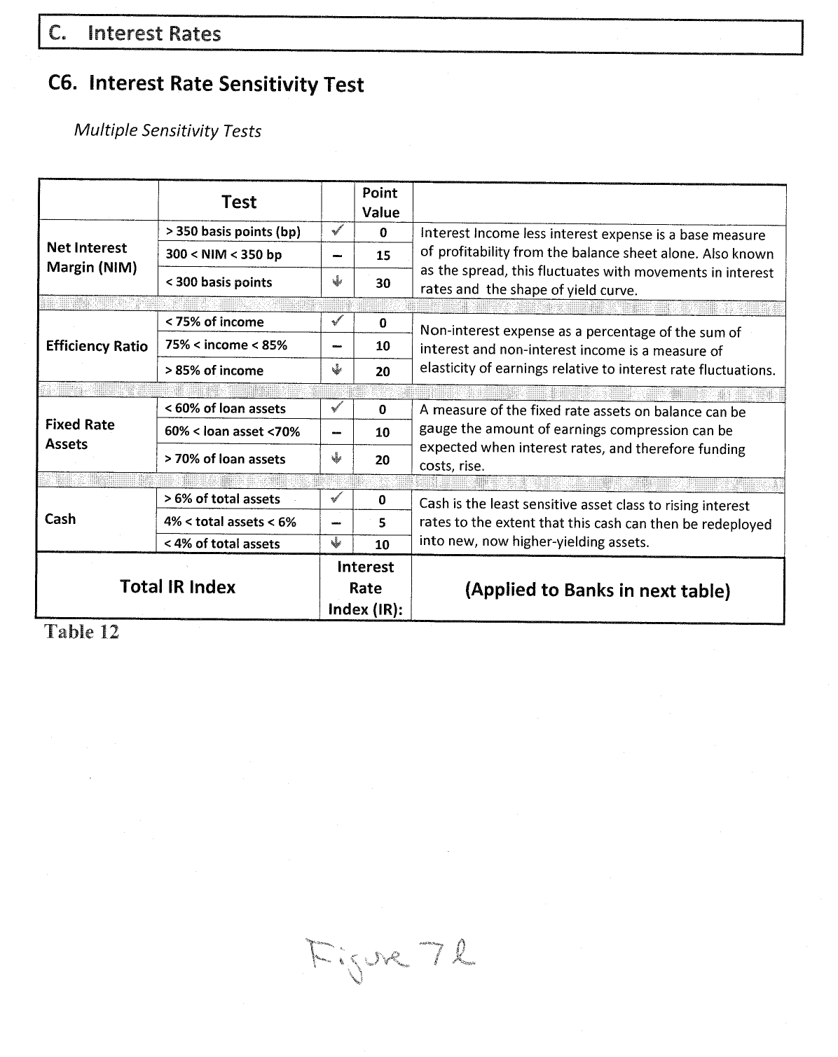

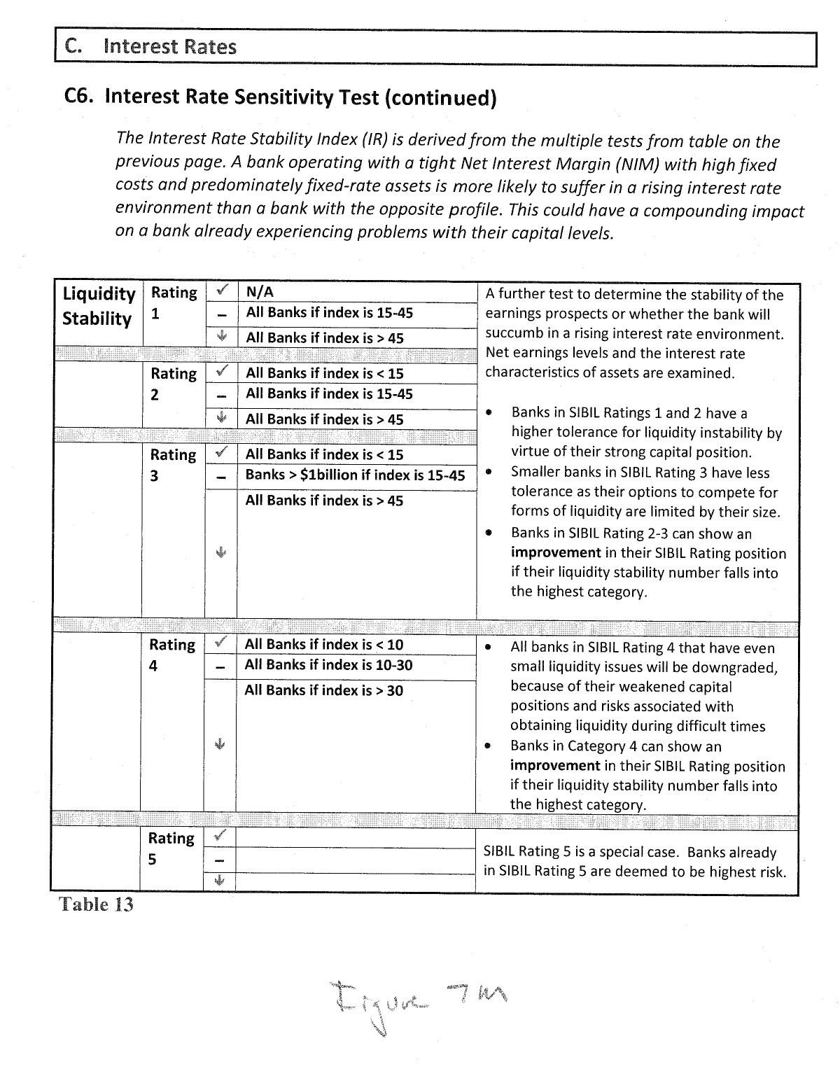

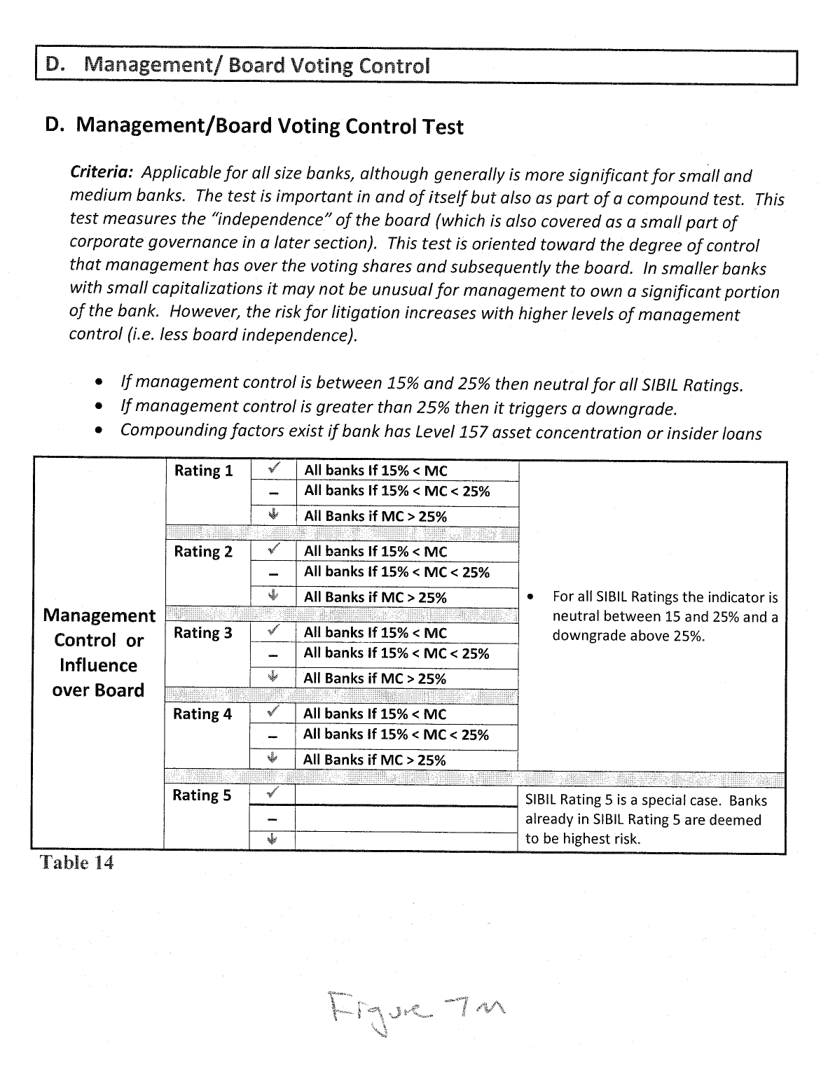

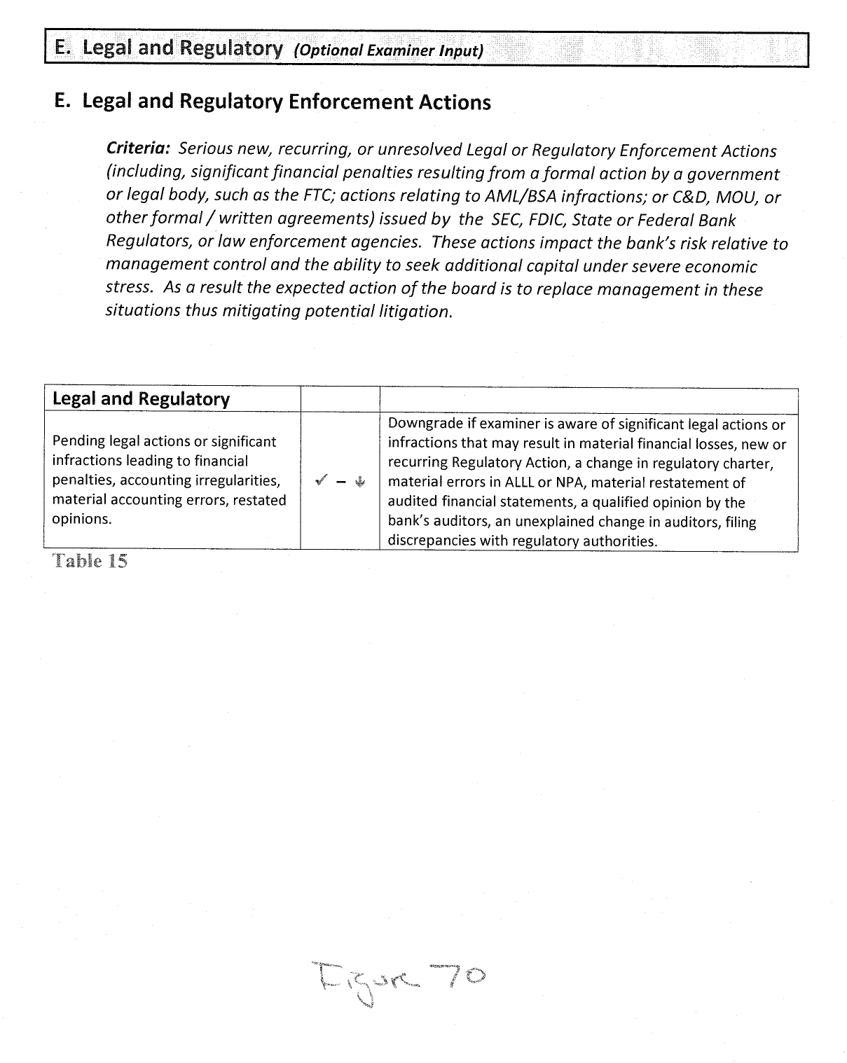

These additional factors, by which a Final SIBIL rating category may be calculated, referenced herein as “Secondary Filters.” As shown in FIG. 6, Secondary Filters may include, but are not limited to, the following: Regulatory Capital and Earnings, Size, Liquidity and Interest Rates, Accounting, whether a bank is public or privately held, Equity Distributions, Management Control, Insider Loans, Econometrics, Strategic Considerations, Legal and Regulatory Considerations, and other Management Considerations. The Secondary Filters are more fully described in FIGS. 7a-7p.

In accordance with the system method of the present disclosure, each Secondary Filter is evaluated based, for example, on data drawn from a data repository as further described herein, and may in addition be based on additional information that is derived from data in the data repository and other public and private sources. As illustrated and described in FIG. 6 and FIGS. 7a-7p, the application Secondary Filter results in an indicator falling into one of four categories: a) no impact on the final SIBIL rating (symbolically indicated by a checkmark), b) a neutral effect on the final SIBIL rating (symbolically indicated by a dash), c) a decrease in the rating by a partial or full decrement to a lower rating (symbolically indicated by one or more down arrows), of d) an increase in the rating by a partial or full decrement to a higher rating (symbolically indicated by one or more up arrows).

Significantly, the system and method of the present disclosure may isolate the impact of external stresses on assets and liabilities of financial institutions and may eliminate extraneous (non-stress) issues and “noise” involved with existing financial modeling methodologies and systems. Furthermore, they may present the relative impact of these stresses on specific characteristics of assets and liabilities allowing a comparative analysis of the magnitude of changes caused by a common set of stresses. The stresses, when combined, may contribute to the “net cumulative impact” of those stresses on the assets and liabilities. The system and method may further include a presentation process that facilitates the analysis and review of the results.

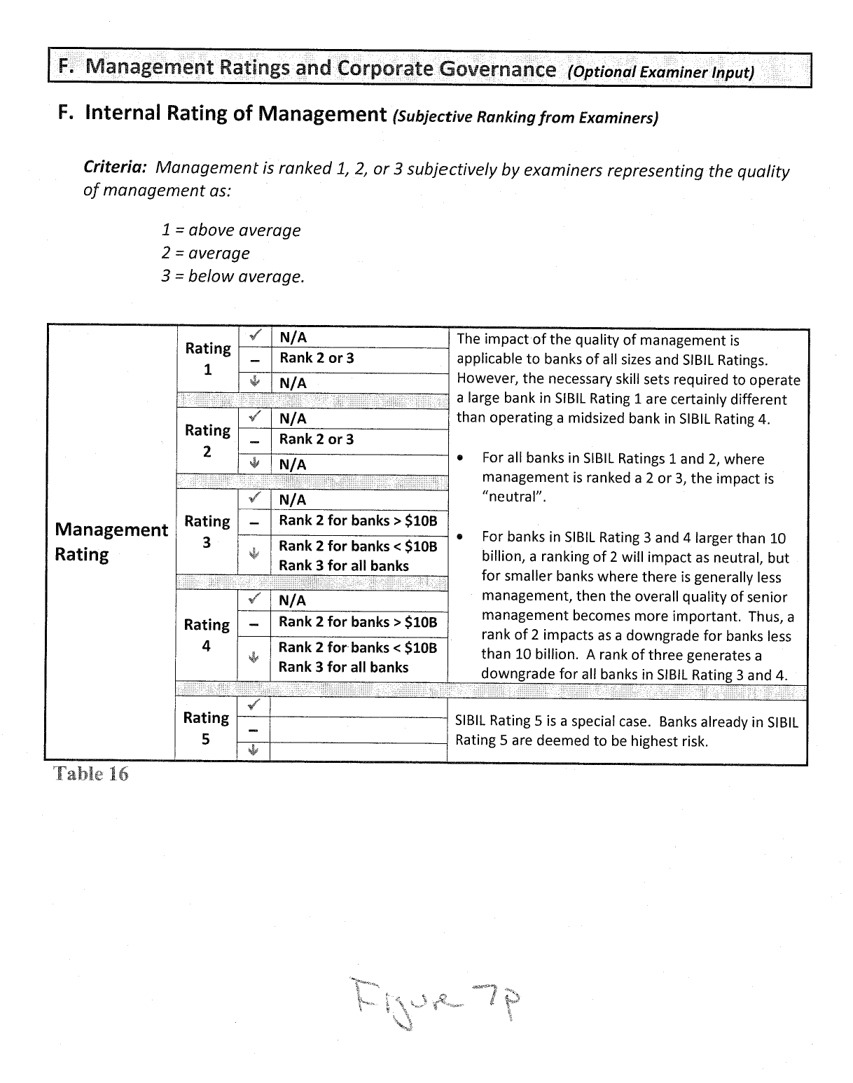

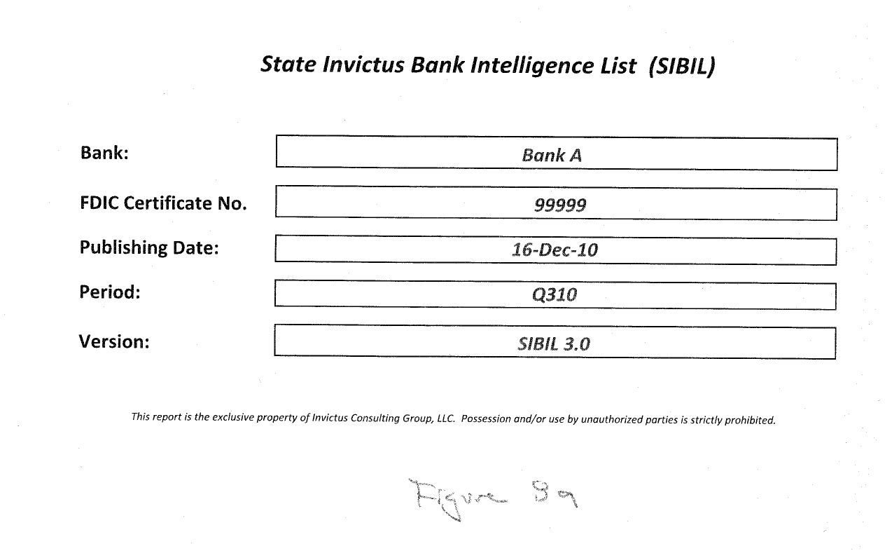

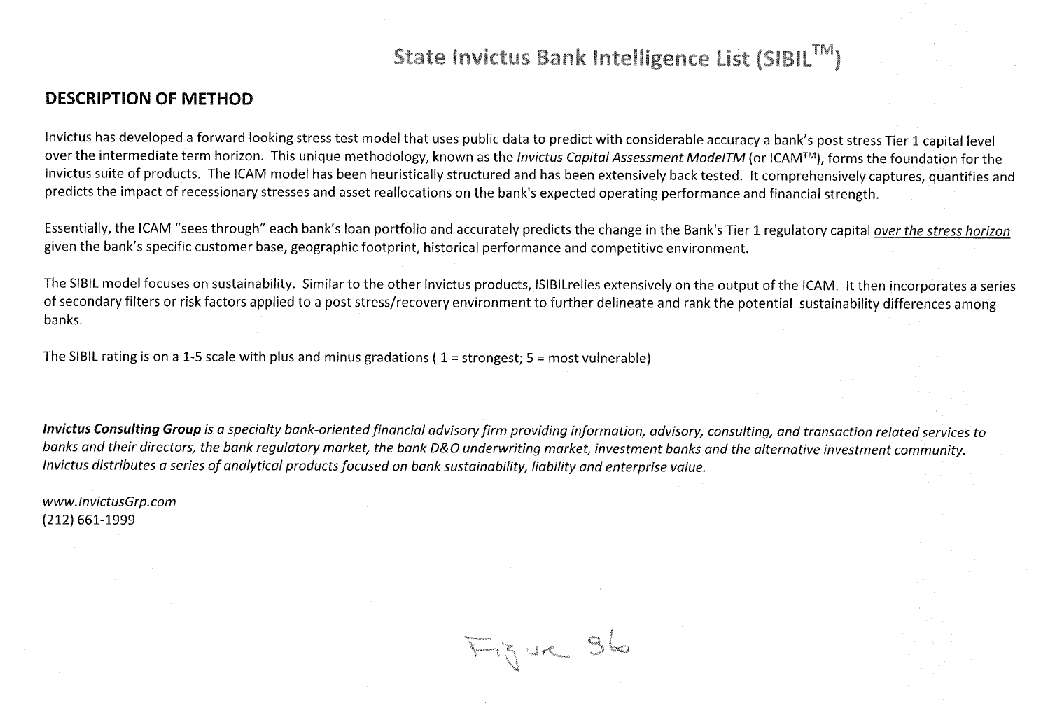

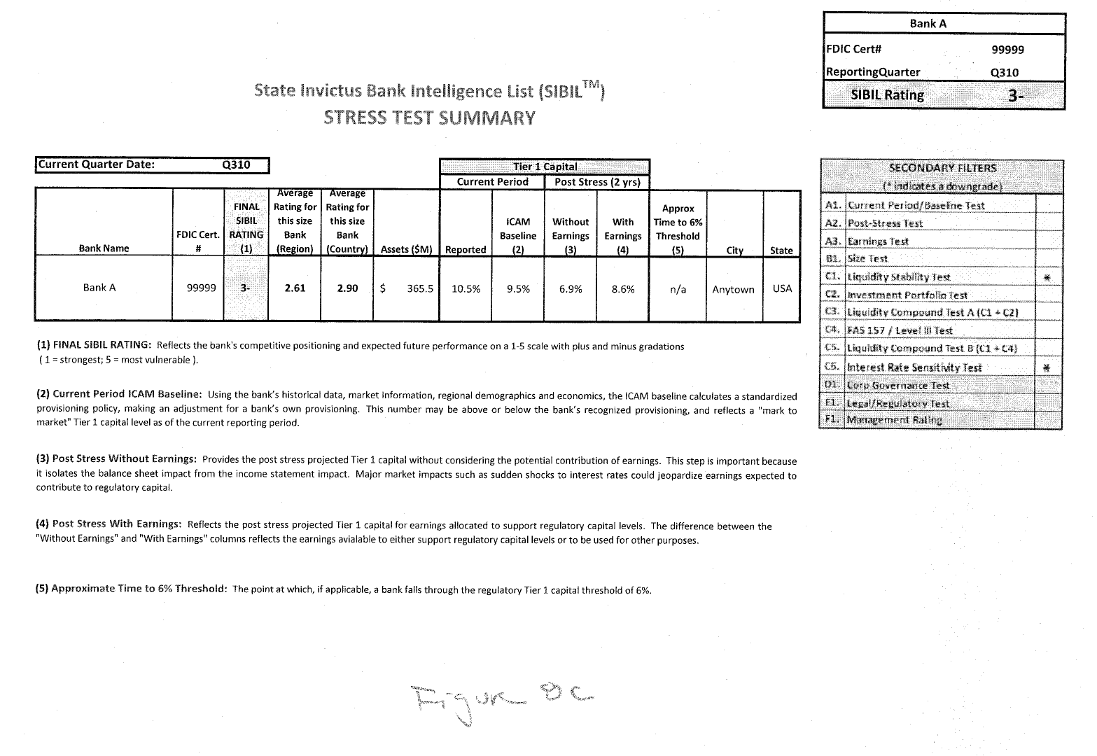

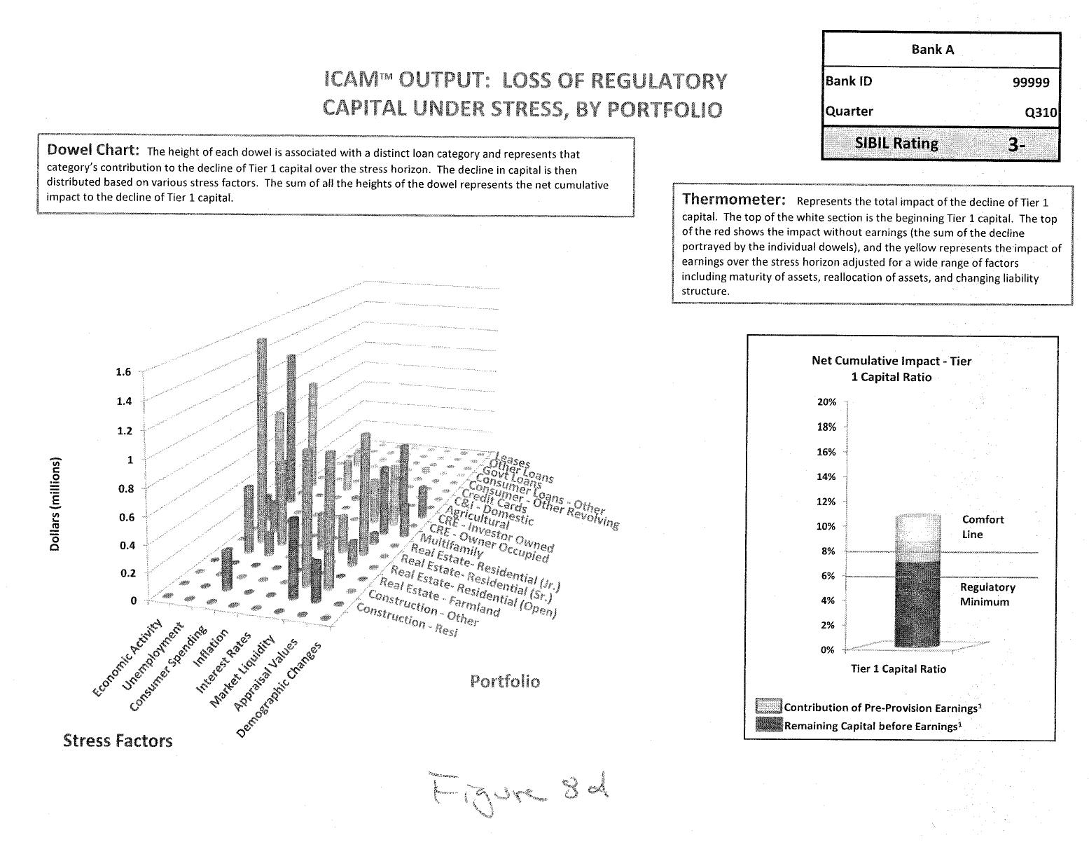

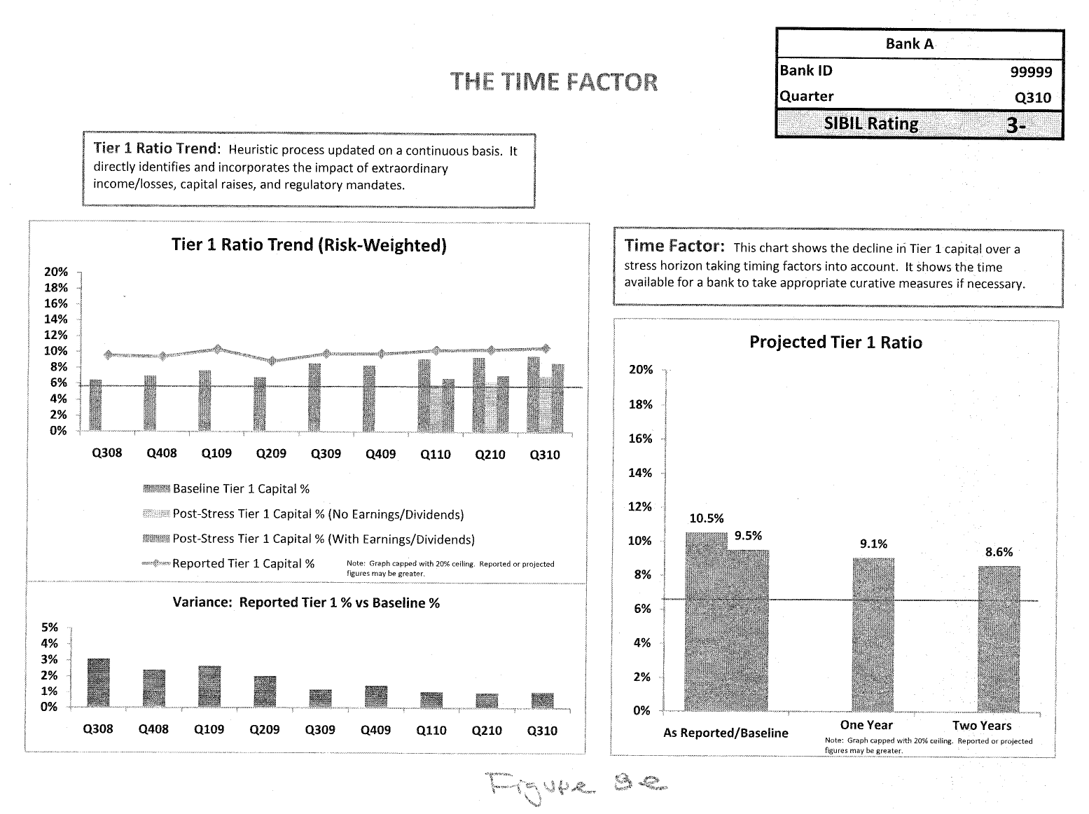

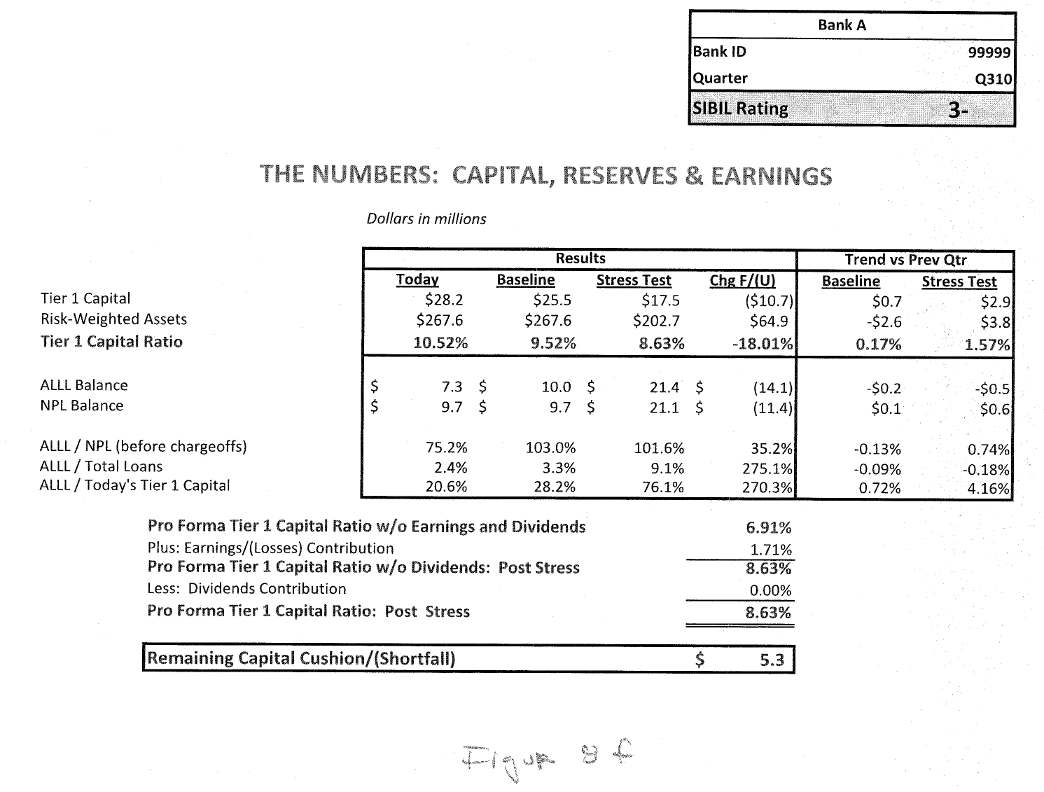

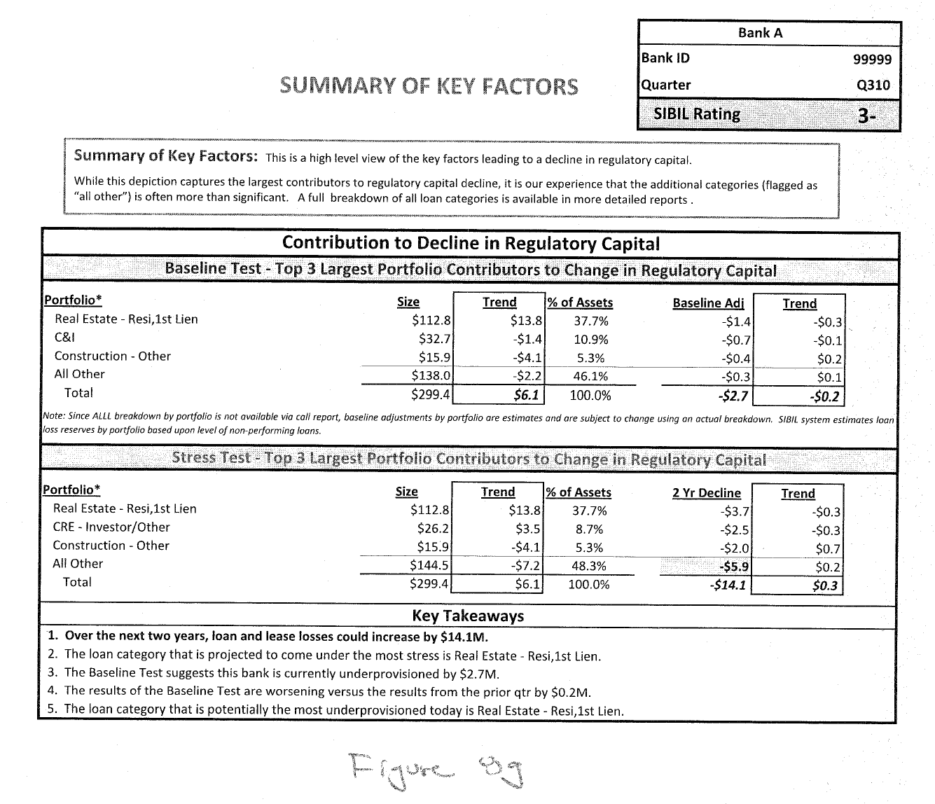

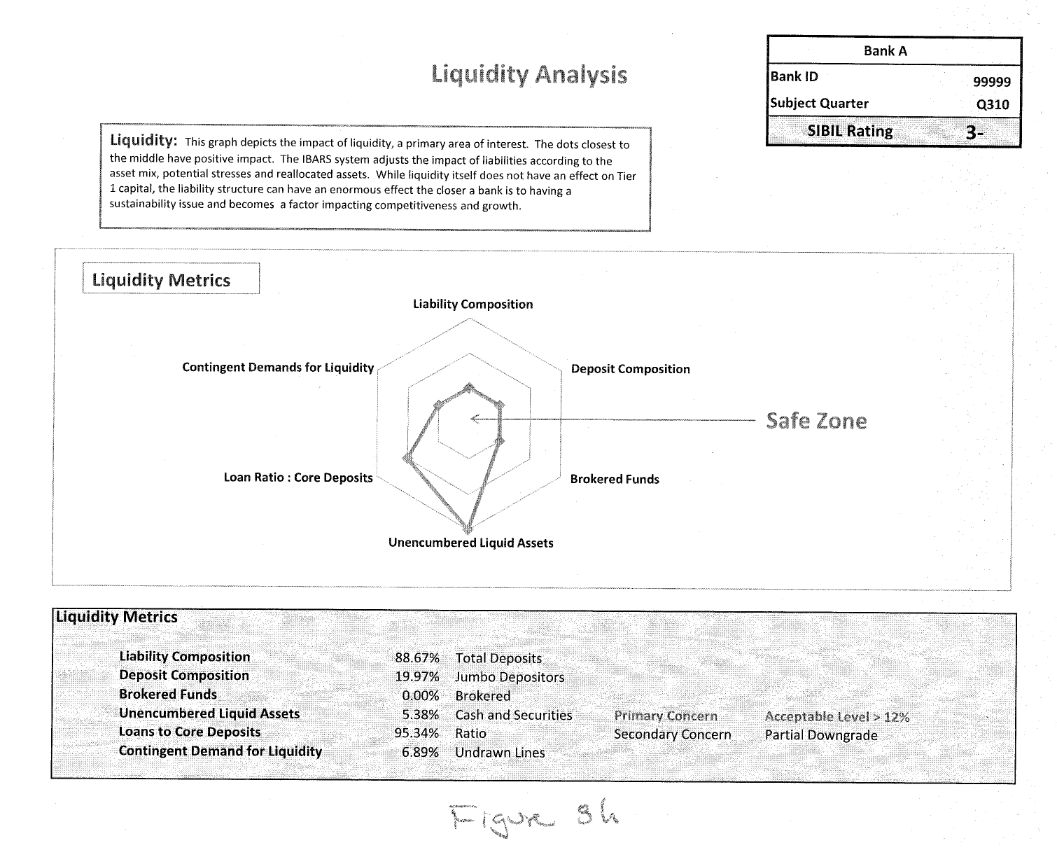

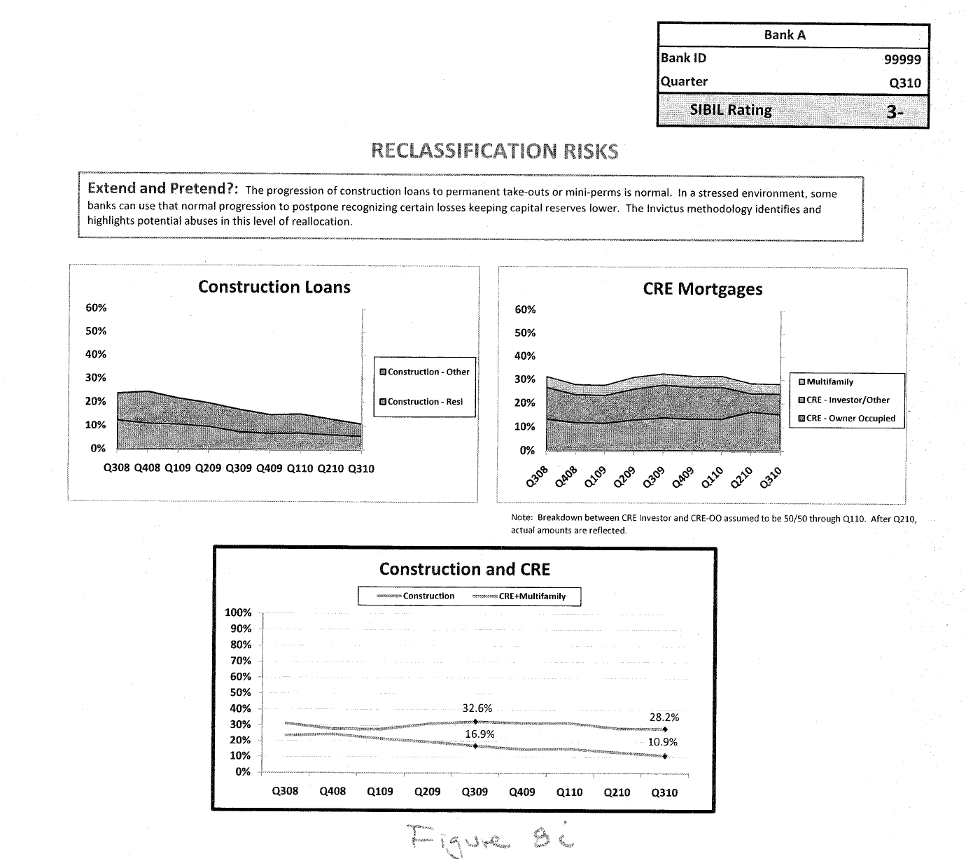

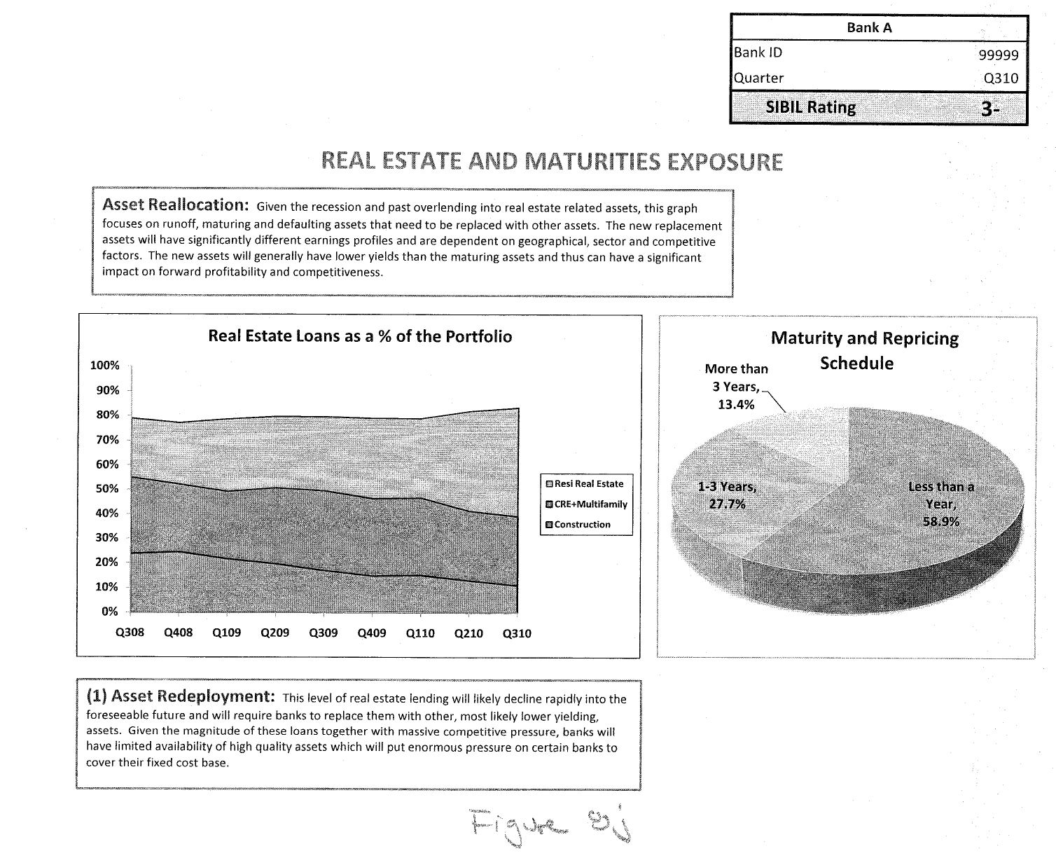

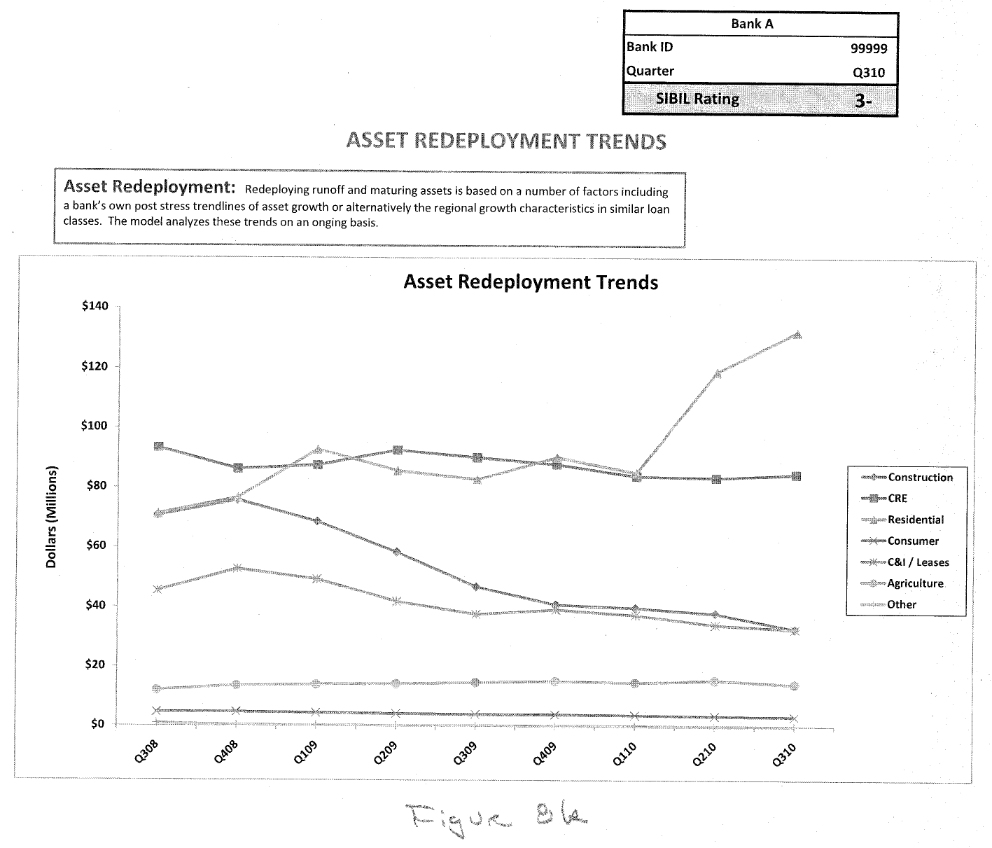

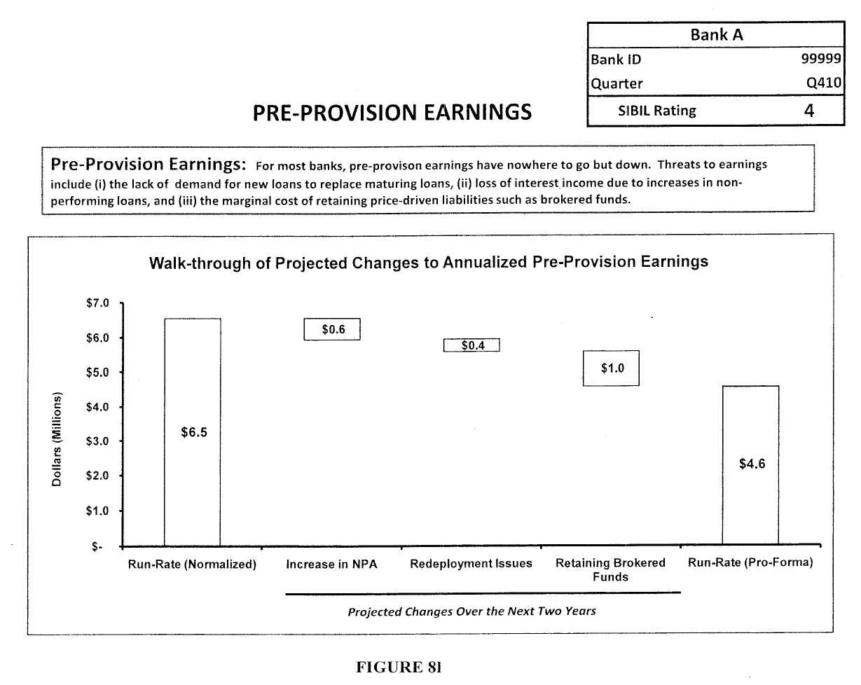

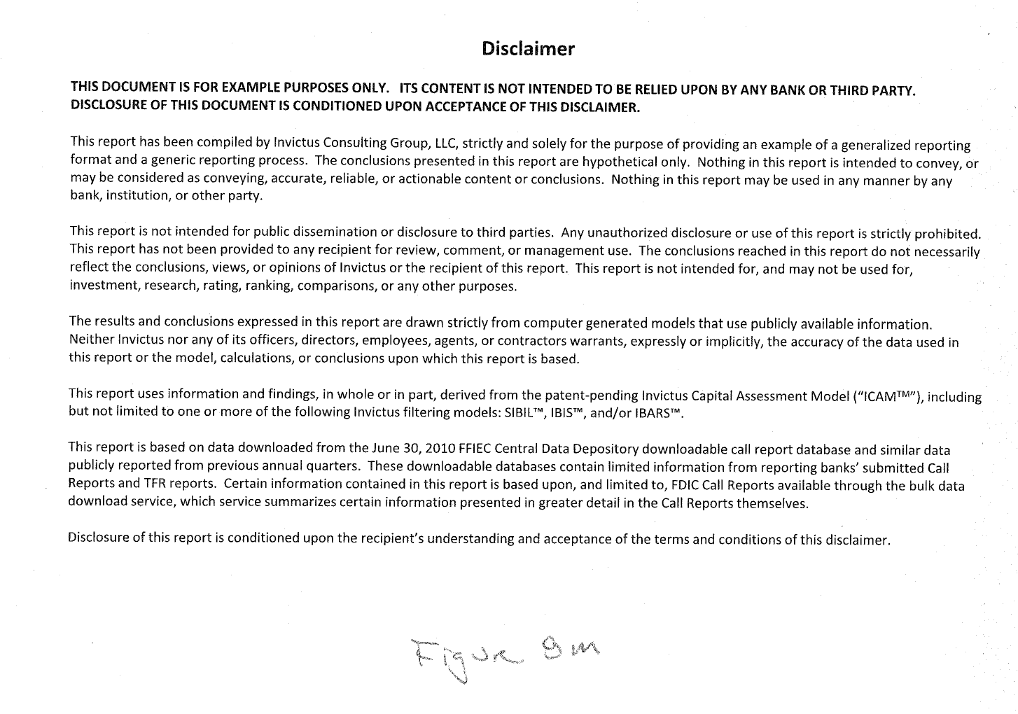

Further in accordance with the system and method of the present disclosure, as an output of the presentation process, FIGS. 8a-8m illustrate an exemplary report providing details concerning a sample bank's performance in view of the final SIBIL rating. Output may be printed, displayed on a display, or provided electronically in the form of HTML, flat files, PDF, SharePoint, Excel, and BI & data mining applications.

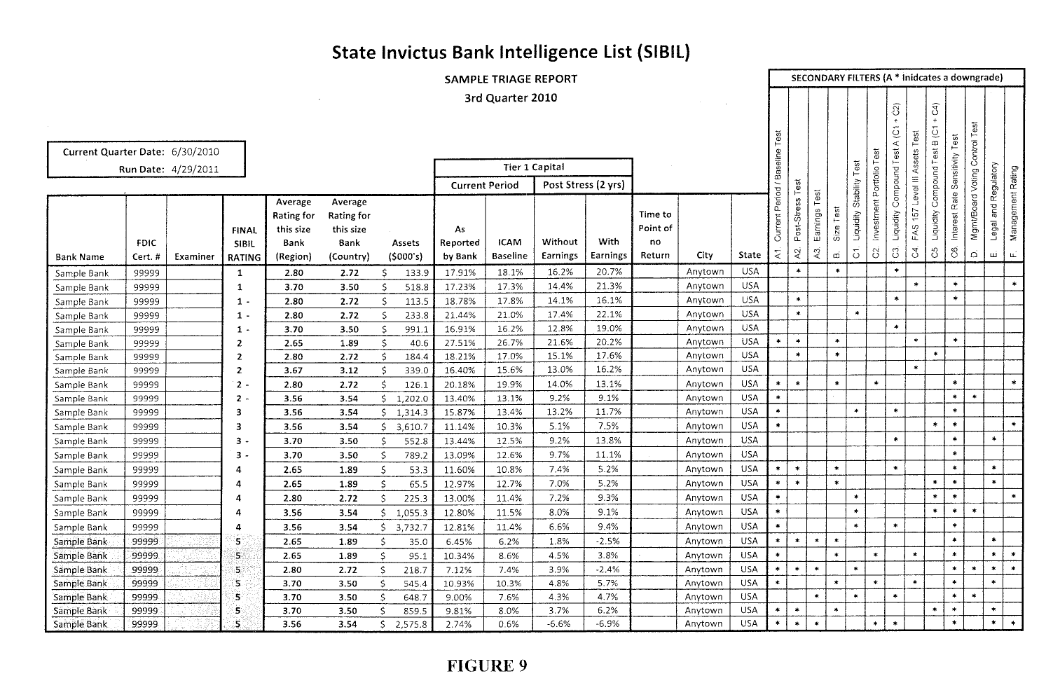

FIG. 9 illustrates a second exemplary report providing summary performance information for a group of banks The report of FIG. 9 is directed to enable a user to quickly prioritize banks demanding attention on the basis of their overall performance (“triage”).

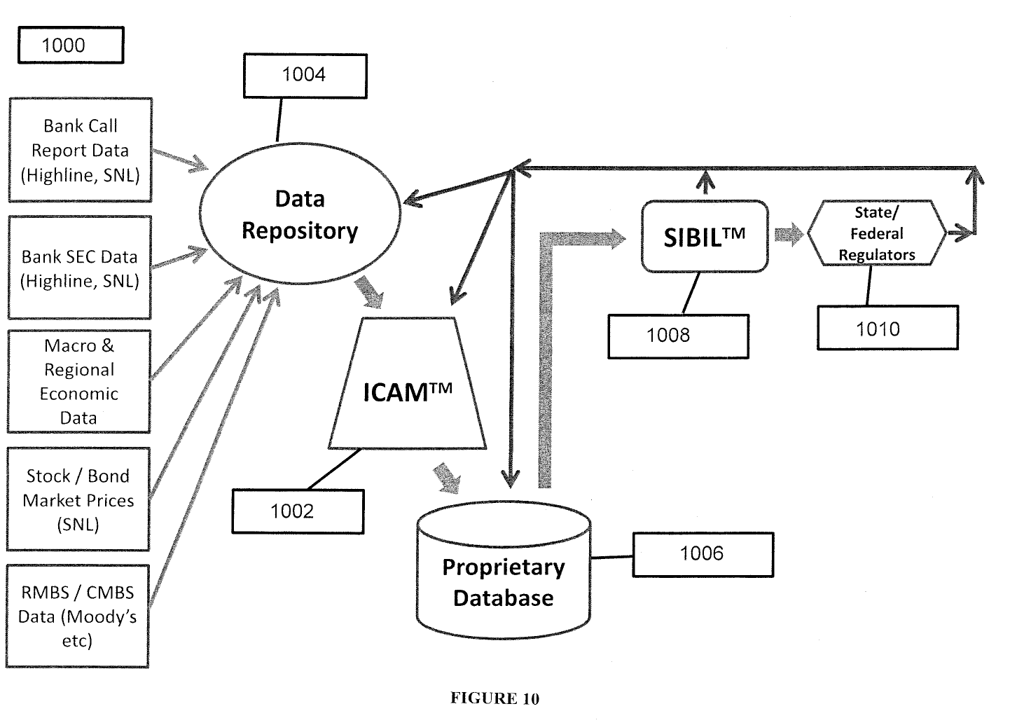

FIG. 10 shows a system architecture 1000 consistent with aspects of the system and method of the present disclosure. In the system architecture 1000, various macroeconomic data, market data and bank data (provided by an associated bank and/or other sources) are collected and stored in a data repository 1004. These data are retrieved and processed within a capital assessment component (“ICAM”) 1002 that prepares the baseline and stress risk analyses, and the cumulative analyses as described supra herein (for example, including the Net Cumulative Impact-Tier 1 Capital Ratio), and stores the results of these analyses in a database 1006. The database 1006 is accessed by a secondary analysis engine 1008 that prepares a comparative analysis of the bank according to the cumulative analyses and applies the Secondary Filters to prepare a final, adjusted analysis in accordance with other secondary risk factors, as described supra herein. In addition, the secondary analysis engine 1008 is configure to interact with the ICAM 1002 to prepare analytical reports for insurers 1010.

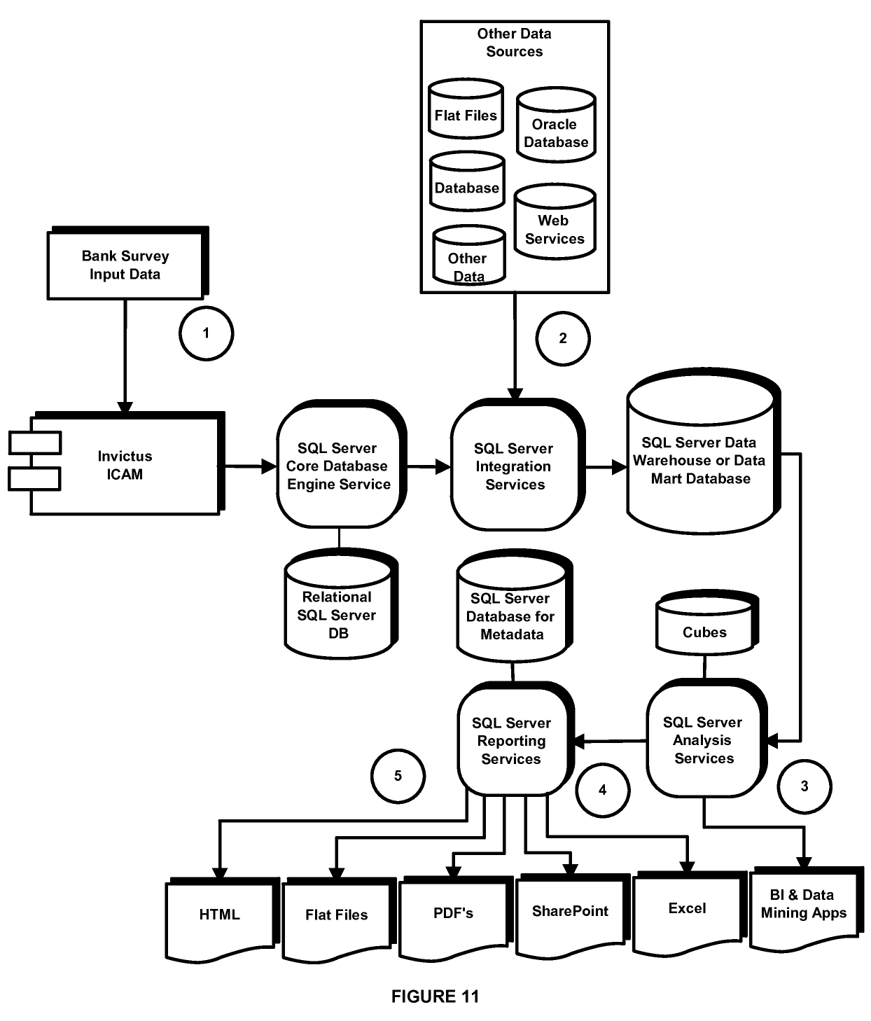

FIG. 11 shows an example of a database management (DBM) architecture (for example, SQL Server 2008) that may be used in support of the ICAM 1002, secondary analysis engine 1008, repository 1004 and database 1006 of FIG. 10. As illustrated in FIG. 11, bank survey data gathered at step 1 may be integrated with data from other data sources in an integration service component of the architecture for delivery to a warehouse component of the architecture. At step 3, an analysis services component of the architecture employs retrieves the warehoused data for delivery to data mining applications, and to a reporting services component that is configured to prepare reports in a variety of formats (for example, in the form of HTML, flat files, PDF, SharePoint, Excel, for printing or electronic display). Returning to steps 1 and 2, the architecture of FIG. 11 may be configured to receive input from banks, insurance carriers, and others, and write entries to one or more of a relational database and the warehouse in a real-time.

The system and method of the disclosure described above are an exemplary aspects of the disclosure. The exemplary aspect of the present invention are not intended to limit the disclosure to those aspects described. Rather, the disclosure is also intended to cover alternatives, modifications, and equivalents as may be included within the spirit and scope of the disclosure as defined by the appended claims.

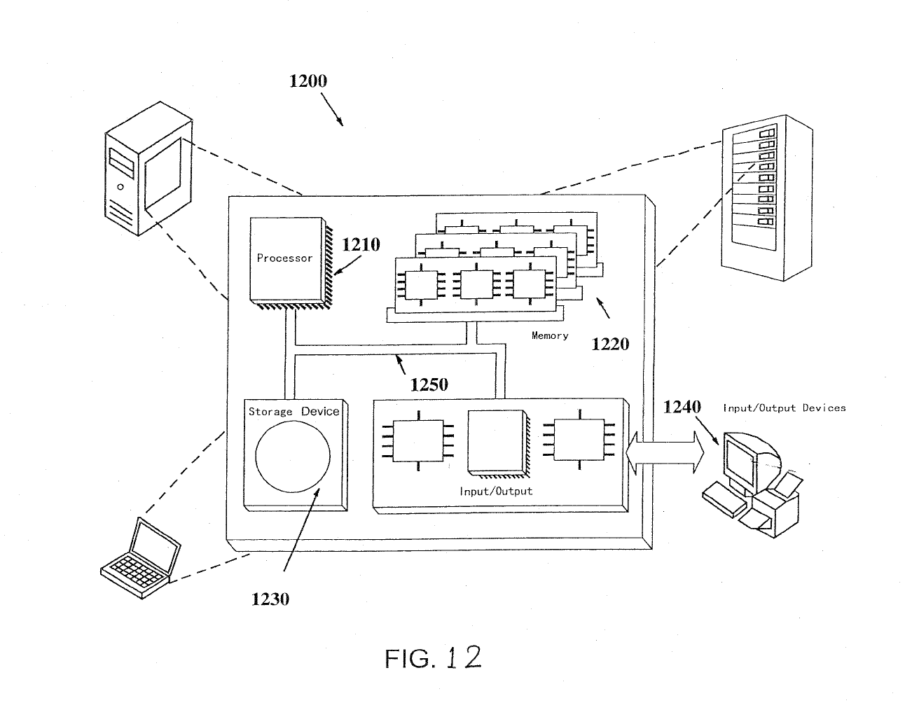

Elements of present disclosure are typically implemented on one or more general purpose computers as shown in FIG. 12. The computer system of FIG. 12 shows computer system 1200 that may execute at least some of the operations described above. Computer system 1200 may include processor 1210, memory 1220, storage device 1230, and input/output devices 1240. Some or all of the components 1210, 1220, 1230, and 1240 may be interconnected via system bus 1250. Processor 1210 may be single or multi-threaded and may have one or more cores. Processor 1210 may execute instructions, such as those stored in memory 1220 or in storage device 1230. Information may be received and output using one or more input/output devices 1240.

Memory 1220 may store information and may be a computer-readable medium, such as volatile or non volatile memory. Storage device 1230 may provide storage for system 1200 and may be a computer-readable medium. In various aspects, storage device 1230 may be a flash memory device, a floppy disk device, a hard disk device, an optical disk device, or a tape device.

Input/output devices 1240 may provide input/output operations for system 1200. Input/output devices 1240 may include a keyboard, pointing device, and microphone. Input/output devices 1240 may further include a display unit for displaying graphical user interfaces, speaker, and printer.

The features described may be implemented in digital electronic circuitry, or in computer hardware, firmware, software, or in combinations thereof. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output.

The described features may be implemented in one or more computer programs that are executable on a programmable system including at least one programmable processor coupled to receive data and instructions from, and to transmit data and instructions to, a data storage system, at least one input device, and at least one output device. A computer program may include set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors of any kind of computer. Generally, a processor may receive instructions and data from a read only memory or a random access memory or both. Such a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable, disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks may include, e.g., a LAN, a WAN, and the computers and networks forming the Internet.

The computer system may include clients and servers. A client and server may be remote from each other and interact through a network, such as the described one. The relationship of client and server may arise by virtue of computer programs running on the respective computers and having a client-server relationship to each other.

Numerous additional modifications and variations of the present disclosure are possible in view of the above teachings. It is therefore to be understood that within the scope of the appended claims, the present disclosure may be practiced other than as specifically described herein.

1. A computer program product, comprising a computer usable medium having a computer readable program code embodied therein, said computer readable program code adapted to be executed to implement a method for assessing a financial institution's capital risk, the method comprising the steps of:
receiving financial information;
processing the financial information to obtain a scenario for a capital risk;
assigning one of a number of predetermined rating categories to the financial institution according to the scenario;
applying one or more secondary filters pertaining to additional risks selected by a state regulator to adjust the assigned rating category;
displaying the scenario and the adjusted rating category on a display device.
